(19) United States
(12) Patent Application Publication
(10) Pub. No.: US 2026/0120609 A1
(43) Pub. Date: Apr. 30, 2026

(54) ELECTRONIC DEVICE, METHOD, AND NON-TRANSITORY COMPUTER READABLE STORAGE MEDIUM FOR CONTROLLING OF VIEWING ANGLE OF SCREEN ON DISPLAY PANEL

(71) Applicant: Samsung Electronics Co., Ltd., Suwon-si (KR)

(72) Inventors: Sungyoung SHIN, Suwon-si (KR); Minsuk UHM, Suwon-si (KR); Haechang LEE, Suwon-si (KR); Keehyon PARK, Suwon-si (KR); Byungduk YANG, Suwon-si (KR); Kwangtai KIM, Suwon-si (KR); Donghyun YEOM, Suwon-si (KR)

(21) Appl. No.: 19/432,496

(22) Filed: Dec. 24, 2025

Related U.S. Application Data
(63) Continuation of application No. PCT/KR2025/007662, filed on Jun. 4, 2025.

(30) Foreign Application Priority Data
Jul. 16, 2024 (KR) 10-2024-0093877
Aug. 21, 2024 (KR) 10-2024-0111878

(51) Int. Cl. G09G 3/20

(52) U.S. Cl. CPC G09G 3/2074; G09G 2300/0426; G09G 2320/068; G09G 2358/00

(57) ABSTRACT

An electronic device may include a display panel. The display panel may include a first layer including first light transmittance portions and/or second light transmittance portions smaller than the first light transmittance portions. The display panel may include a second layer, disposed below the first layer, including first sub-pixels respectively disposed below the first light transmittance portions and second sub-pixels respectively disposed below the second light transmittance portions. The electronic device may include display driver circuitry.

### CROSS-REFERENCE TO RELATED APPLICATIONS

This application is a continuation application of International Application No. PCT/KR2025/007662, filed on Jun. 4, 2025, in the Korean Intellectual Property Receiving Office, and claiming priority to Korean Patent Application No. 10-2024-0093877 filed Jul. 16, 2024 and to Korean Patent Application No. 10-2024-0111878 filed Aug. 21, 2024, the disclosures of which are all hereby incorporated by reference herein in their entireties.

### TECHNICAL FIELD

Certain example embodiments may relate to an electronic device, a method, and/or a non-transitory computer-readable storage medium for controlling a viewing angle of a screen on a display panel.

### BACKGROUND

An electronic device may display visual information through a display panel. For example, the visual information may be displayed through pixels in the display panel. For example, each of the pixels may include at least one first sub-pixel emitting light having a first color, at least one second sub-pixel emitting light having a second color, and at least one third sub-pixel emitting light having a third color.

The above-described information may be provided as a related art for the purpose of helping to understand the present disclosure. No claim or determination is raised as to whether any of the above-described information may be applied as a prior art related to the present disclosure.

### SUMMARY

An example electronic device may comprise a display panel. The display panel may comprise a first layer including first light transmittance portions and second light transmittance portions smaller than the first light transmittance portions. The display panel may comprise a second layer, disposed below at least the first layer of the display panel, including first sub-pixels respectively disposed below at least the first light transmittance portions and second sub-pixels respectively disposed below at least the second light transmittance portions. The electronic device may comprise display driver circuitry. The display driver circuitry may be configured to display, via the display panel, a screen with a first viewing angle by controlling emitting of the first sub-pixels using grayscale values in a first grayscale range and controlling emitting of the second sub-pixels using grayscale values in the first grayscale range. The display driver circuitry may be configured to display, via the display panel, a screen with a second viewing angle narrower than the first viewing angle by controlling emitting of the first sub-pixels using grayscale values in a second grayscale range narrower than the first grayscale range and controlling emitting of the second sub-pixels using grayscale values in the first grayscale range.

An example method may be executed in an electronic device with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions. The method may comprise displaying, via the display panel, a screen with a first viewing angle by controlling emitting of the first sub-pixels using grayscale values in a first grayscale range and controlling emitting of the second sub-pixels using grayscale values in the first grayscale range. The method may comprise displaying, via the display panel, a screen with a second viewing angle narrower than the first viewing angle by controlling emitting of the first sub-pixels using grayscale values in a second grayscale range narrower than the first grayscale range and controlling emitting of the second sub-pixels using grayscale values in the first grayscale range.

An example non-transitory computer-readable storage medium may store one or more programs. The one or more programs may comprise instructions which, when executed by an electronic device (e.g., by a processor(s), comprising processing circuitry, of the electronic device) with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions, cause the electronic device to display, via the display panel, a screen with a first viewing angle by controlling emitting of the first sub-pixels using grayscale values in a first grayscale range and controlling emitting of the second sub-pixels using grayscale values in the first grayscale range. The one or more programs may comprise instructions which, when executed by the electronic device, cause the electronic device to display, via the display panel, a screen with a second viewing angle narrower than the first viewing angle by controlling emitting of the first sub-pixels using grayscale values in a second grayscale range narrower than the first grayscale range and controlling emitting of the second sub-pixels using grayscale values in the first grayscale range.

An example electronic device may comprise a display panel. The display panel may comprise a first layer including first light transmittance portions and second light transmittance portions smaller than the first light transmittance portions. The display panel may comprise a second layer, disposed below the first layer of the display panel, including first sub-pixels respectively disposed below the first light transmittance portions and second sub-pixels respectively disposed below the second light transmittance portions. The electronic device may comprise display driver circuitry. The display driver circuitry may be configured to display, via the display panel, a screen with a first viewing angle by controlling the first sub-pixels to emit light in a first brightness range and controlling the second sub-pixels to emit light in the first brightness range. The display driver circuitry may be configured to display, via the display panel, a screen with a second viewing angle narrower than the first viewing angle by controlling the first sub-pixels to emit light in a second brightness range narrower than the first brightness range and controlling the second sub-pixels to emit light in the first brightness range.

An example method may be executed in an electronic device with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions. The method may comprise displaying, via the display panel, a screen with a first viewing angle by controlling the first sub-pixels to emit light in a first brightness range and controlling the second sub-pixels to emit light in the first brightness range. The method may comprise displaying, via the display panel, a screen with a second viewing angle narrower than the first viewing angle by controlling the first sub-pixels to emit light in a second brightness range narrower than the first brightness range and controlling the second sub-pixels to emit light in the first brightness range.

An example non-transitory computer-readable storage medium i may store one or more programs. The one or more programs may comprise instructions which, when executed by an electronic device with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions, cause the electronic device to display, via the display panel, a screen with a first viewing angle by controlling the first sub-pixels to emit light in a first brightness range and controlling the second sub-pixels to emit light in the first brightness range. The one or more programs may comprise instructions which, when executed by the electronic device, cause the electronic device to display, via the display panel, a screen with a second viewing angle narrower than the first viewing angle by controlling the first sub-pixels to emit light in a second brightness range narrower than the first brightness range and controlling the second sub-pixels to emit light in the first brightness range.

An example electronic device may comprise a display panel. The display panel may comprise a first layer including first light transmittance portions and second light transmittance portions smaller than the first light transmittance portions. The display panel may comprise a second layer, disposed below the first layer of the display panel, including first sub-pixels respectively disposed below the first light transmittance portions and second sub-pixels respectively disposed below the second light transmittance portions. The electronic device may comprise display driver circuitry. The display driver circuitry may be configured to, based on a normal display mode, display a screen on the display panel, by emitting light through the first sub-pixels and emitting light through the second sub-pixels. The display driver circuitry may be configured to, based on changing the normal display mode to a first privacy display mode while the screen is maintained on the display panel, cease emitting light through the first sub-pixels. The display driver circuitry may be configured to, based on changing the normal display mode to a second privacy display mode while the screen is maintained on the display panel, narrow a brightness range of light emitted through the first sub-pixels.

Am example method may be executed in an electronic device with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions. The method may comprise, based on a normal display mode, displaying a screen on the display panel, by emitting light through the first sub-pixels and emitting light through the second sub-pixels. The method may comprise, based on changing the normal display mode to a first privacy display mode while the screen is maintained on the display panel, ceasing emitting light through the first sub-pixels. The method may comprise, based on changing the normal display mode to a second privacy display mode while the screen is maintained on the display panel, narrowing a brightness range of light emitted through the first sub-pixels.

An example non-transitory computer-readable storage medium may store one or more programs. The one or more programs may comprise instructions which, when executed by an electronic device with a display panel comprising a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions, cause the electronic device to, based on a normal display mode, display a screen on the display panel, by emitting light through the first sub-pixels and emitting light through the second sub-pixels. The one or more programs may comprise instructions which, when executed by the electronic device, cause the electronic device to, based on changing the normal display mode to a first privacy display mode while the screen is maintained on the display panel, cease emitting light through the first sub-pixels. The one or more programs may comprise instructions which, when executed by the electronic device, cause the electronic device to, based on changing the normal display mode to a second privacy display mode while the screen is maintained on the display panel, narrow a brightness range of light emitted through the first sub-pixels.

### BRIEF DESCRIPTION OF THE DRAWINGS

FIG. 1 illustrates an example of changing a viewing angle of a screen.

FIG. 2 is a schematic view of an exemplary electronic device.

FIG. 3 illustrates an example configuration of a display panel of an example electronic device.

FIG. 4 is a cross-sectional view of a display panel according to the example configuration of FIG. 3.

FIG. 5 illustrates another example configuration of a display panel of an electronic device.

FIG. 6 is a cross-sectional view of a display panel according to the example configuration of FIG. 5.

FIG. 7 is a chart illustrating a grayscale range used to control first sub-pixels and a grayscale range used to control second sub-pixels while activating a normal display mode, in an example embodiment.

FIG. 8 is a chart illustrating a grayscale range used to control first sub-pixels and a grayscale range used to control second sub-pixels while activating a first privacy display mode, in an example embodiment.

FIG. 9 is a chart illustrating a grayscale range used to control first sub-pixels and a grayscale range used to control second sub-pixels while activating a second privacy display mode, in an example embodiment.

FIG. 10 is a chart illustrating a change of a grayscale range used to control first sub-pixels while activating a second privacy display mode, in an example embodiment.

FIG. 11 is a block diagram of an electronic device in a network environment according to various example embodiments.

FIG. 12 is a block diagram of a display module according to various example embodiments.

FIG. 13 is a schematic view of an exemplary artificial intelligence (AI) system.

### DETAILED DESCRIPTION

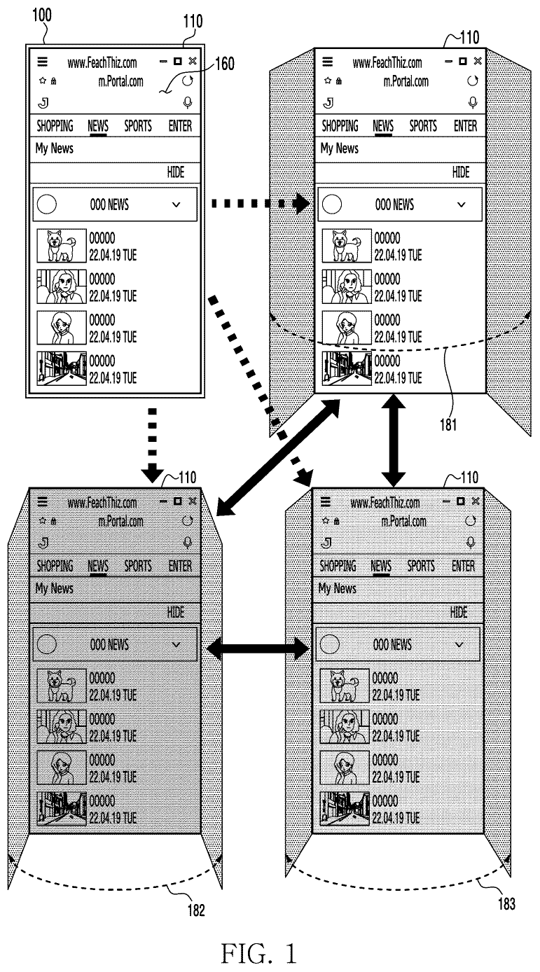

FIG. 1 illustrates an example of changing a viewing angle of a screen.

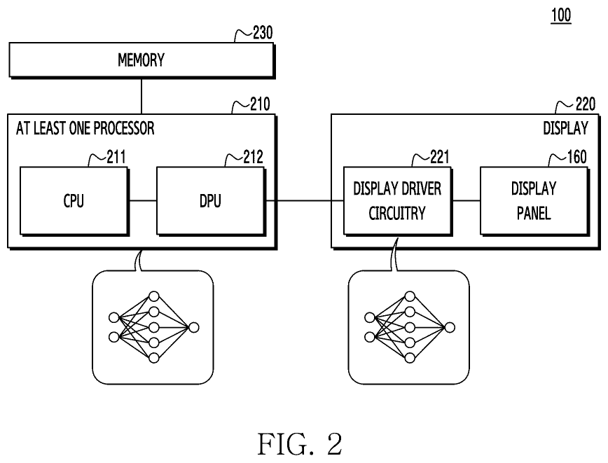

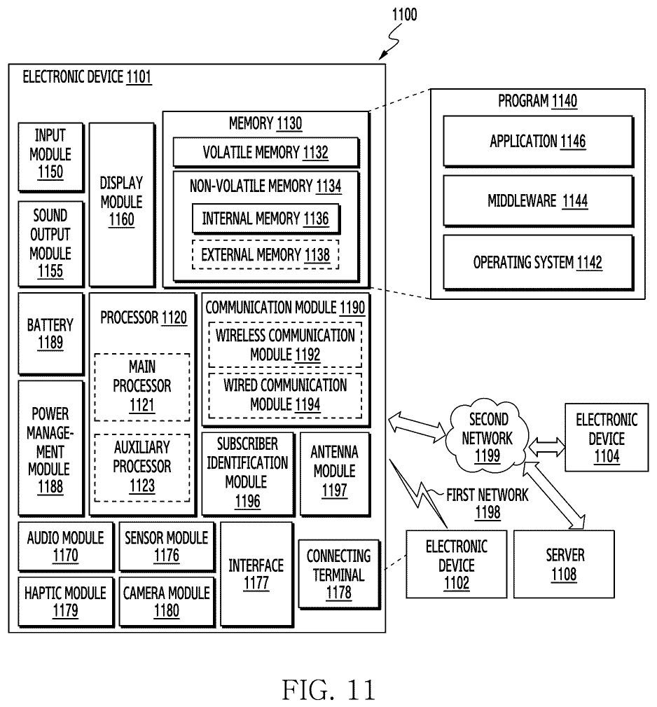

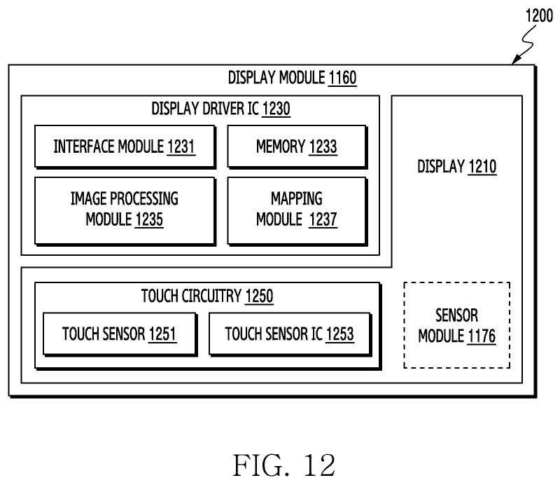

Referring to FIG. 1, an electronic device 100 (e.g., the electronic device 1101 of FIG. 11) may display a screen 110 on a display panel 160 (e.g., the display panel 160 of FIG. 2, the display 1210 of FIG. 12). The screen 110 may include one or more contents (or one or more media contents). The screen 110 may include one or more visual objects. The screen 110 may be displayed on the display panel 160 to provide information.

The electronic device 100 may display the screen 110 with a viewing angle 181 on the display panel 160. For example, the viewing angle 181 of the screen 110 may be wider than a viewing angle 182 of the screen 110 and a viewing angle 183 of the screen 110 described below. For example, the screen 110 with the viewing angle 181 may be displayed on the display panel 160 in accordance with a normal display mode. For example, the viewing angle 181 may be wider than a first threshold viewing angle (e.g., the viewing angle 182) and may be wider than a second threshold viewing angle (e.g., the viewing angle 183) that is wider than the first threshold viewing angle.

The electronic device 100 may provide a function (or feature) for user privacy with respect to a display on the display panel 160. For example, the electronic device 100 may provide one or more display modes that narrow a viewing angle of at least a portion of the screen 110 displayed on the display panel 160, for the function.

The one or more display modes may include a first privacy display mode. The first privacy display mode may be described as a privacy display mode that provides the first threshold viewing angle (e.g., the viewing angle 182). For example, the electronic device 100 may display, on the display panel 160, the screen 110 with the viewing angle 182, which is the first threshold viewing angle, in accordance with the first privacy display mode. The first privacy display mode may be changed or switched from the normal display mode. For example, the electronic device 100 may, based on the first privacy display mode changed from the normal display mode, change displaying the screen 110 with the viewing angle 181 to displaying the screen 110 with the viewing angle 182. For example, the electronic device 100 may, based on changing the normal display mode to the first privacy display mode, cease (or terminate) (or deactivate) displaying the screen 110 with the viewing angle 181 and display the screen 110 with the viewing angle 182. For example, the electronic device 100 may, based on the first privacy display mode changed from a second privacy display mode described below, change displaying the screen 110 with the viewing angle 183 to displaying the screen 110 with the viewing angle 182. For example, the electronic device 100 may, based on changing the second privacy display mode to the first privacy display mode, cease (or terminate) (or deactivate) displaying the screen 110 with the viewing angle 183 and display the screen 110 with the viewing angle 182. For example, the electronic device 100 may, based on changing the first privacy display mode to the normal display mode, change displaying the screen 110 with the viewing angle 182 to displaying the screen 110 with the viewing angle 181. As a non-limiting example, the first threshold viewing angle may be described as a narrowest viewing angle capable of being provided through the display panel 160.

The one or more display modes may include a second privacy display mode. The second privacy display mode may be described as a privacy display mode providing a viewing angle (e.g., the viewing angle 183) that is wider than the first threshold viewing angle and is narrower than or equal to the second threshold viewing angle. The second privacy display mode may be described as a privacy display mode adjusting visibility from a surrounding space (e.g., a second space described below) of the display panel 160. For example, visibility from the surrounding space of the display panel 160 provided according to the second privacy display mode may differ from visibility from the surrounding space of the display panel 160 provided according to the first privacy display mode.

For example, the electronic device 100 may display, on the display panel 160, the screen 110 with a viewing angle 183 that is wider than the first threshold viewing angle and is narrower than the second threshold viewing angle, in accordance with the second privacy display mode. The second threshold viewing angle may be described as a widest viewing angle capable of being provided in accordance with the second privacy display mode. The viewing angle 183 may be a viewing angle provided in accordance with the second privacy display mode and may be between the first threshold viewing angle and the second threshold viewing angle. The second privacy display mode may be described as an intermediate display mode between the normal display mode and the first privacy display mode. The second privacy display mode may be described as a display mode that adjusts a viewing angle of a screen displayed on the display panel 160 between the first threshold viewing angle and the second threshold viewing angle. For example, the electronic device 100 may, based on the second privacy display mode changed from the normal display mode, change displaying the screen 110 with the viewing angle 181 to displaying the screen 110 with the viewing angle 183. For example, the electronic device 100 may, based on changing the normal display mode to the second privacy display mode, cease (or terminate) (or deactivate) displaying the screen 110 with the viewing angle 181 and display the screen 110 with the viewing angle 183. For example, the electronic device 100 may, based on the second privacy display mode changed from the first privacy display mode, change displaying the screen 110 with the viewing angle 182 to displaying the screen 110 with the viewing angle 183. For example, the electronic device 100 may, based on changing the first privacy display mode to the second privacy display mode, cease (or terminate) (or deactivate) displaying the screen 110 with the viewing angle 182 and display the screen 110 with the viewing angle 183. For example, the electronic device 100 may, based on changing the second privacy display mode to the normal display mode, change displaying the screen 110 with the viewing angle 183 to displaying the screen 110 with the viewing angle 181.

As a non-limiting example, the first privacy display mode and the second privacy display mode may be replaced with a single privacy display mode (or a privacy display mode). For example, the single privacy display mode may be described as a mode that sets a viewing angle of the screen 110 displayed on the display panel 160 as a viewing angle narrower than the viewing angle 181. For example, the normal display mode may be described as a mode that deactivates a function for user privacy of the electronic device 100, and the single privacy display mode may be described as a mode that activates a function for user privacy of the electronic device 100. For example, the electronic device 100 may adjust (or change) a viewing angle of the screen 110 displayed on the display panel 160 between the first threshold viewing angle and the second threshold viewing angle, in accordance with the single privacy display mode. The single privacy display mode may include only the second privacy display mode.

FIG. 2 is a schematic view of an exemplary electronic device.

Referring to FIG. 2, an electronic device 100 may include at least one processor 210, a display 220, and memory 230 comprising processing circuitry. The electronic device 100 may include at least a portion of an electronic device 1101 of FIG. 11 or may correspond to at least a portion of the electronic device 1101 of FIG. 11.

The at least one processor 210, comprising processing circuitry, may include at least a portion of a processor 1120 of FIG. 11 or correspond to at least a portion of the processor 1120 of FIG. 11. Each processor herein comprises processing circuitry. The at least one processor 210 may include a central processing unit (CPU) 211 (e.g., including processing circuitry) and a display processing unit (DPU) 212 (e.g., including processing circuitry). As a non-limiting example, the at least one processor 210 may further include a graphic processing unit (GPU) (e.g., including processing circuitry). The at least one processor 210 may be configured to execute instructions stored in the memory 230.

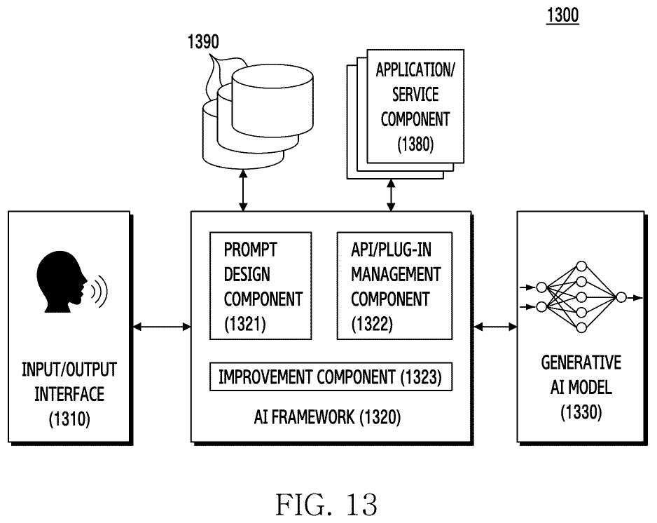

As a non-limiting example, the at least one processor 210 may perform at least a portion of operations described below, by using a trained model (e.g., a generative artificial intelligence (AI) model 1330 of FIG. 13). For example, the at least one processor 210 may, by using the trained model, determine changing the normal display mode to the first privacy display mode, determine changing the normal display mode to the second privacy display mode, determine changing the first privacy display mode to the second privacy display mode, determine changing the first privacy display mode to the normal display mode, determine changing the second privacy display mode to the normal display mode, and/or may determine changing the second privacy display mode to the first privacy display mode.

As a non-limiting example, the at least one processor 210 may, based on a determination to change the normal display mode to the first privacy display mode, transmit at least one first command indicating the first privacy display mode to the display driver circuitry 221. For example, the display driver circuitry 221 may, based on the at least one first command, change the normal display mode to the first privacy display mode. As a non-limiting example, the at least one processor 210 may, based on a determination to change the normal display mode to the second privacy display mode, transmit at least one second command indicating the second privacy display mode to the display driver circuitry 221. For example, the display driver circuitry 221 may, based on the at least one second command, change the normal display mode to the second privacy display mode.

As a non-limiting example, the at least one processor 210 may, based on a determination to change the first privacy display mode to the normal display mode, transmit at least one third command indicating the normal display mode to the display driver circuitry 221. For example, the display driver circuitry 221 may, based on the at least one third command, change the first privacy display mode to the normal display mode. As a non-limiting example, the at least one processor 210 may, based on a determination to change the second privacy display mode to the normal display mode, transmit the at least one third command to the display driver circuitry 221. For example, the display driver circuitry 221 may, based on the at least one third command, change the second privacy display mode to the normal display mode.

The display 220 may include at least a portion of a display module 1160 of FIG. 11 or correspond to at least a portion of the display module 1160 of FIG. 11. The display 220 may include display driver circuitry (or display driver integrated circuitry) 221 and a display panel 160. The display driver circuitry 221 may include at least a portion of a display driver IC 1230 of FIG. 12 or correspond to at least a portion of the display driver IC 1230 of FIG. 12. As a non-limiting example, the display driver circuitry 221 may perform at least a portion of operations described below, by using a trained model (e.g., a generative artificial intelligence (AI) model 1330 of FIG. 13). For example, the display driver circuitry 221 may, by using the trained model, determine a viewing angle of the screen 110 displayed on the display panel 160 while the second privacy display mode (or the single privacy display mode) is activated. The display panel 160 may include at least a portion of a display 1210 of FIG. 12 or correspond to at least a portion of the display 1210 of FIG. 12.

The display 220 may operate or be driven for a command mode, a video mode, a hybrid video mode of a mobile industry processor interface (MIPI) display serial interface (DSI), and/or an adaptive refresh panel (ARP).

The memory 230 may include one or more storage media (or storage mediums). For example, the one or more storage media may include a permanent memory such as a hard drive, a flash memory, and a read-only memory (ROM), a semi-permanent memory such as a random access memory (RAM), any other suitable type of storage assembly, or any combination thereof. The memory 230 may include cache memory, which is one or more different types of memory used to temporarily store data for a function (or feature) of the electronic device 100. The memory 230 may be fixedly embedded in the electronic device 100 or may be incorporated onto one or more suitable types of components (e.g., a subscriber identity module (SIM) card and/or a secure digital (SD) memory card) that are repeatedly insertable into and removable from the electronic device 100. For example, the memory 230 may include at least a portion of memory 1130 of FIG. 11 or correspond to at least a portion of the memory 1130 of FIG. 11.

The memory 230 may store one or more software applications such as an operating system software application, a firmware software application, a media playback software application, a media editing software application, a software application for communication with other users, a translation software application, a digital assistant software application, and/or any other suitable software applications. For example, the one or more software applications may include instructions executable by at least a portion of the at least one processor 210.

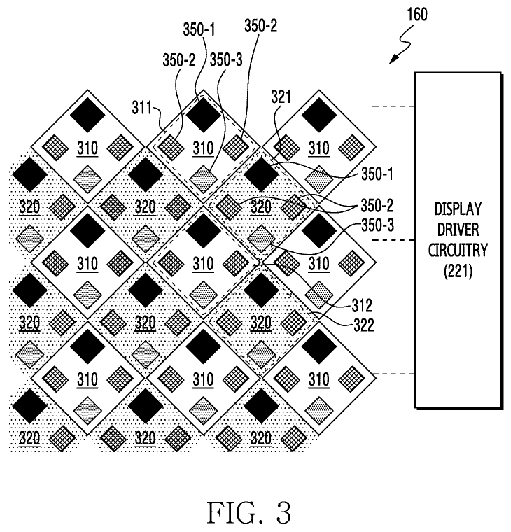

For example, the display panel 160 within the display 220 may have a structure for adjusting a viewing angle of a screen (e.g., the screen 110) displayed on the display panel 160. The structure is described in more detail with reference to FIGS. 3 to 6.

FIG. 3 illustrates an example configuration of a display panel of an electronic device.

Referring to FIG. 3, the display panel 160 may include a plurality of pixels. Each of the pixels may include sub-pixels. The sub-pixels may include a first sub-pixel 350-1 configured to emit light of a first color (e.g., a red color), a second sub-pixel 350-2 configured to emit light of a second color (e.g., a green color), and a third sub-pixel 350-3 configured to emit light of a third color (e.g., a blue color). The sub-pixels may further include a fourth sub-pixel (not shown) configured to emit light of a fourth color (e.g., a white color).

A field of illumination (FOI) of light emitted from one or more of the pixels may be narrower than an FOI of light emitted from other one or more of the pixels. For example, the one or more of the pixels may include a pixel 321 and a pixel 322. For example, the other one or more of the pixels may include a pixel 311 and a pixel 312.

For example, the one or more of the pixels may be positioned within (or inside) a first set 320 of areas in an active area (or display area) of the display panel 160, such as the pixel 321 and the pixel 322. For example, the other one or more of the pixels may be positioned within (or inside) a second set 310 of areas in the active area of the display panel 160, such as the pixel 311 and the pixel 312. As a non-limiting example, areas included in the first set 320 of areas and areas included in the second set 310 of areas may alternate with each other. As a non-limiting example, the areas included in the first set 320 of areas and the areas included in the second set 310 of areas may be included in the active area in an interleaved arrangement.

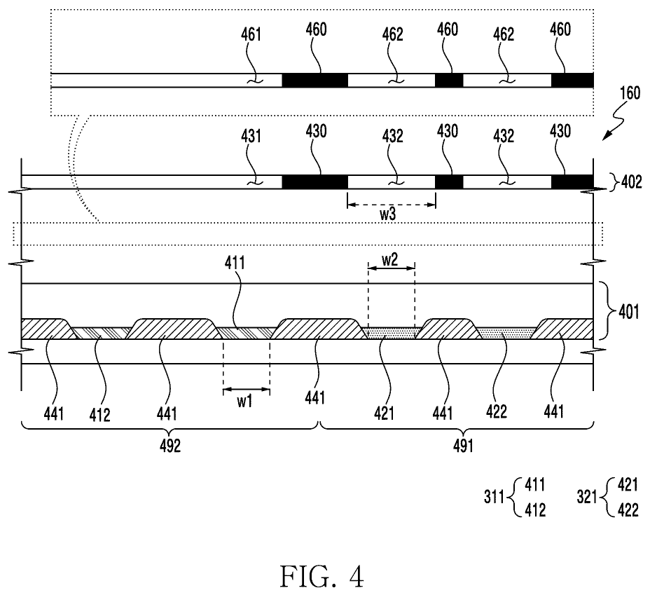

The display panel 160 may include an opaque member in another layer (e.g., another layer 402 of FIG. 4) of the display panel 160 disposed above a layer (e.g., a layer 401 of FIG. 4) of the display panel 160 including the pixels, in order to narrow (or reduce) an FOI of light emitted from the one or more of the pixels compared to an FOI of light emitted from the other one or more of the pixels. The opaque member in the other layer of the display panel 160 may be a structure for narrowing a viewing angle of at least a portion of a screen (e.g., the screen 110) displayed on the display panel 160. The opaque member in the other layer of the display panel 160 may be partially overlying the one or more of the pixels, and may not be overlying the other one or more of the pixels. The opaque member disposed in the other layer of the display panel 160 according to the example configuration of FIG. 3 is described in more detail with reference to FIG. 4.

FIG. 4 is a cross-sectional view of a display panel according to the example configuration of FIG. 3.

Referring to FIG. 4, the display panel 160 may include a layer 401 and another layer 402 disposed (or positioned) on the layer 401. The layer 401 of the display panel 160 may be described as an emission layer 401. The other layer 402 of the display panel 160 may be described as a masking layer 402 (or a mask layer 402) (or a black matrix layer 402).

The layer 401 of the display panel 160 may include a pixel 311 positioned in an area 492 included in a second set 310 of areas, and a pixel 321 positioned in an area 491 included in the first set 320 of areas. The pixel 311 may include a sub-pixel 411 and a sub-pixel 412. The pixel 321 may include a sub-pixel 421 and a sub-pixel 422.

The layer 401 of the display panel 160 may include a pixel definition layer (PDL) 441. The PDL 441 may define a periphery of the pixel 311 and a periphery of the pixel 321. The PDL 441 may define a periphery of the sub-pixel 411 in the pixel 311 and a periphery of the sub-pixel 412 in the pixel 311. The PDL 441 may define a periphery of the sub-pixel 421 in the pixel 321 and a periphery of the sub-pixel 422 in the pixel 321. For example, the PDL 441 may be disposed between the pixel 311 and the pixel 321, may be disposed between at least the sub-pixel 411 and the sub-pixel 412, and/or may be disposed between the sub-pixel 421 and the sub-pixel 422.

As a non-limiting example, a width w1 of the sub-pixel 411, for example defined by the PDL 441 may be equal to a width w2 of the sub-pixel 421, for example defined by the PDL 441. For example, when a color of light emitted from the sub-pixel 411 is identical to a color of light emitted from the sub-pixel 421, a width w1 of the sub-pixel 411 may be equal to a width w2 of the sub-pixel 421. When the color of light emitted from the sub-pixel 411 is different from the color of light emitted from the sub-pixel 421, the width w1 of the sub-pixel 411 may be narrower than the width w2 of the sub-pixel 421. As a non-limiting example, the width w1 of the sub-pixel 411, for example defined by the PDL 441 may be wider than the width w2 of the sub-pixel 421, for example defined by the PDL 441. For example, when the color of light emitted from the sub-pixel 411 is identical to the color of light emitted from the sub-pixel 421, the width w1 of the sub-pixel 411 may be equal to the width w2 of the sub-pixel 421.

The other layer 402 of the display panel 160 may include an opaque member 430 (or a black matrix 430). The opaque member 430 may be included in the other layer 402 of the display panel 160 for the first privacy display mode and the second privacy display mode. For example, the opaque member 430 may be partially overlying the pixel 321 and may not be overlying the pixel 311, in order to narrow an FOI of light emitted from the pixel 321 compared to an FOI of light emitted from the pixel 311. For example, the opaque member 430 may partially overlap the pixel 321 among the pixel 311 and the pixel 321. For example, the opaque member 430 may be disposed above (or over) a portion of the PDL 441, defining the pixel 321 and defining sub-pixels (e.g., the sub-pixel 421 and the sub-pixel 422) in the pixel 321, and may not be disposed above another portion of the PDL 441, defining the pixel 311 and defining sub-pixels (e.g., the sub-pixel 411 and the sub-pixel 412) in the pixel 311. For example, the opaque member 430 may include an opening 431 (or a first light transmittance portion 431 (or a first light transmittance area 431)) disposed over the pixel 311, and openings 432 (or second light transmittance portions 432 (or second light transmittance areas 432)) disposed over the pixel 321. The opening 431 may be aligned with the pixel 311. The opening 431 may overlap sub-pixels within the pixel 311. The opening 431 may surround the sub-pixels within the pixel 311 when the display panel 160 is viewed from above. The sub-pixels within the pixel 311 may be positioned inside the opening 431 when the display panel 160 is viewed from above. The openings 432 may respectively be aligned with sub-pixels within the pixel 321. The openings 432 may respectively overlap the sub-pixels within the pixel 321. The openings 432 may respectively surround the sub-pixels within the pixel 321 when the display panel 160 is viewed from above. The sub-pixels within the pixel 321 may respectively be positioned inside the openings 432 when the display panel 160 is viewed from above.

For example, a size of the opening 431 may be larger than a size of each of the openings 432. For example, the sub-pixels (e.g., the sub-pixel 411 and the sub-pixel 412) within the pixel 311 may be positioned below the opening 431 (or the first light transmittance portion 431). For example, each of the sub-pixels (e.g., the sub-pixel 421 and the sub-pixel 422) within the pixel 321 may respectively be positioned below the openings 432 (or the second light transmittance portions 432). The sub-pixels within the pixel 311 may be described as first sub-pixels disposed below a light transmittance portion (e.g., the first light transmittance portion 431) in the other layer 402, and the sub-pixels within the pixel 321 may be described as second sub-pixels respectively disposed below other light transmittance portions (e.g., the second light transmittance portions 432) in the other layer 402, which are smaller than the light transmittance portion (e.g., the first light transmittance portion 431) in the other layer 402. Regarding “below,” refer to the drawings and to example non-limiting elevations and/or positions shown in one or more figures for examples.

As a non-limiting example, a width w3 of an opening of the openings 432 may be equal to a width w2 of the sub-pixel 421. As a non-limiting example, a width w3 of an opening of the openings 432 may be wider than a width w2 of the sub-pixel 421. As a non-limiting example, a width w3 of an opening of the openings 432 may be narrower than a width w2 of the sub-pixel 421.

As a non-limiting example, the display panel 160 may further include at least one layer disposed between at least the layer 401 and the other layer 402.

For example, the at least one layer may include a color filter layer (not illustrated in FIG. 4). The color filter layer may include an opaque member 460 including opaque portions positioned between at least the PDL 441 and the opaque member 430. For example, the opaque member 460 included in the color filter layer of the display panel 160 may include (or define) an opening 461 (or a light transmittance portion 461) corresponding to the opening 431 and openings 462 (or light transmittance portions 462) respectively corresponding to the openings 432. The opaque member 460 defining the opening 461 and the openings 462 may be included in the display panel 160 to guide light emitted (or transmitted) toward each of the openings 432. For example, light from the sub-pixel 421 may be emitted (or transmitted) to an opening, among the openings 432, aligned with the sub-pixel 421, by the opaque member 460. For example, light from the sub-pixel 422 may be emitted (or transmitted) to an opening, among the openings 432, aligned with the sub-pixel 422, by the opaque member 460. The color filter layer may be disposed above (or on) (or over) a touch layer between at least the layer 401 and the other layer 402. The touch layer may be used to identify a touch input on the display panel 160.

For example, the at least one layer may include a layer disposed above the color filter layer. The layer disposed above the color filter layer may include an opaque member 460 including opaque portions positioned between at least the PDL 441 and the opaque member 430. For example, the opaque member 460 included in the layer of the display panel 160 disposed above the color filter layer of the display panel 160 may include an opening 461 (or a light transmittance portion 461) corresponding to the opening 431 and openings 462 (or light transmittance portions 462) respectively corresponding to the openings 432. The opaque member 460 defining the opening 461 and the openings 462 may be included in the display panel 160 to guide light emitted (or transmitted) toward each of the openings 432. For example, light from the sub-pixel 421 may be emitted (or transmitted) to an opening, among the openings 432, aligned with the sub-pixel 421, by the opaque member 460. For example, light from the sub-pixel 422 may be emitted (or transmitted) to an opening, among the openings 432, aligned with the sub-pixel 422, by the opaque member 460. The color filter (CF) layer may be disposed between at least the layer including the opaque member 460 and a touch layer. The touch layer may be used to identify a touch input on the display panel 160.

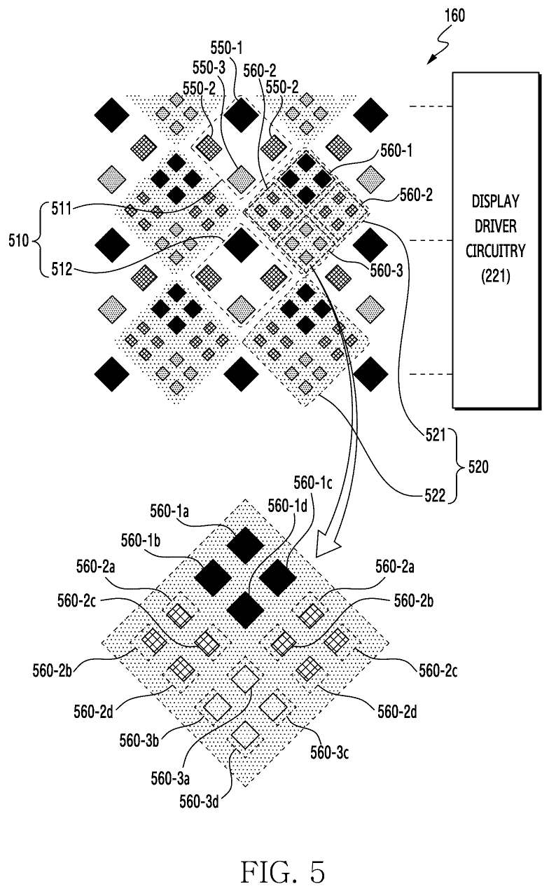

FIG. 5 illustrates another example configuration of a display panel of an electronic device.

Referring to FIG. 5, the display panel 160 may include a plurality of pixels. Each of the plurality of pixels may include first pixels 510 and second pixels 520. For example, the first pixels 510 may include a pixel 511 and a pixel 512. For example, the second pixels 520 may include a pixel 521 and a pixel 522. As a non-limiting example, the first pixels 510 and the second pixels 520 may alternate with each other. As a non-limiting example, the first pixels 510 and the second pixels 520 may be disposed in an interleaved arrangement.

The first pixels 510 may include sub-pixels. The sub-pixels may include a first sub-pixel 550-1 configured to emit light in a first color (e.g., a red color), a second sub-pixel 550-2 configured to emit light in a second color (e.g., a green color), and a third sub-pixel 550-3 configured to emit light in a third color (e.g., a blue color). The sub-pixels may further include a fourth sub-pixel (not illustrated) configured to emit light in a fourth color (e.g., a white color).

The second pixels 520 may include sub-pixels. The sub-pixels may include a first sub-pixel 560-1 configured to emit light in a first color (e.g., a red color), a second sub-pixel 560-2 configured to emit light in a second color (e.g., a green color), and a third sub-pixel 560-3 configured to emit light in a third color (e.g., a blue color). The sub-pixels may further include a fourth sub-pixel (not illustrated) configured to emit light in a fourth color (e.g., a white color).

Each of the sub-pixels in each of the second pixels 520 may include portions spaced apart from each other. For example, the first sub-pixel 560-1 may include a first portion 560-1a of the first sub-pixel 560-1, a second portion 560-1b of the first sub-pixel 560-1, a third portion 560-1c of the first sub-pixel 560-1, and a fourth portion 560-1d of the first sub-pixel 560-1. The first portion 560-1a of the first sub-pixel 560-1, the second portion 560-1b of the first sub-pixel 560-1, the third portion 560-1c of the first sub-pixel 560-1, and the fourth portion 560-1d of the first sub-pixel 560-1 may be spaced apart from each other. The first portion 560-1a of the first sub-pixel 560-1, the second portion 560-1b of the first sub-pixel 560-1, the third portion 560-1c of the first sub-pixel 560-1, and the fourth portion 560-1d of the first sub-pixel 560-1 may be described as micro-pixels of the first sub-pixel 560-1. For example, the second sub-pixel 560-2 may include a first portion 560-2a of the second sub-pixel 560-2, a second portion 560-2b of the second sub-pixel 560-2, a third portion 560-2c of the second sub-pixel 560-2, and a fourth portion 560-2d of the second sub-pixel 560-2. The first portion 560-2a of the second sub-pixel 560-2, the second portion 560-2b of the second sub-pixel 560-2, the third portion 560-2c of the second sub-pixel 560-2, and the fourth portion 560-2d of the second sub-pixel 560-2 may be spaced apart from each other. For example, the first portion 560-2a of the second sub-pixel 560-2, the second portion 560-2b of the second sub-pixel 560-2, the third portion 560-2c of the second sub-pixel 560-2, and the fourth portion 560-2d of the second sub-pixel 560-2 may be described as micro-pixels of the second sub-pixel 560-2. For example, the third sub-pixel 560-3 may include a first portion 560-3a of the third sub-pixel 560-3, a second portion 560-3b of the third sub-pixel 560-3, a third portion 560-3c of the third sub-pixel 560-3, and a fourth portion 560-3d of the third sub-pixel 560-3. The first portion 560-3a of the third sub-pixel 560-3, the second portion 560-3b of the third sub-pixel 560-3, the third portion 560-3c of the third sub-pixel 560-3, and the fourth portion 560-3d of the third sub-pixel 560-3 may be spaced apart from each other. For example, the first portion 560-3a of the third sub-pixel 560-3, the second portion 560-3b of the third sub-pixel 560-3, the third portion 560-3c of the third sub-pixel 560-3, and the fourth portion 560-3d of the third sub-pixel 560-3 may be described as micro-pixels of the third sub-pixel 560-3.

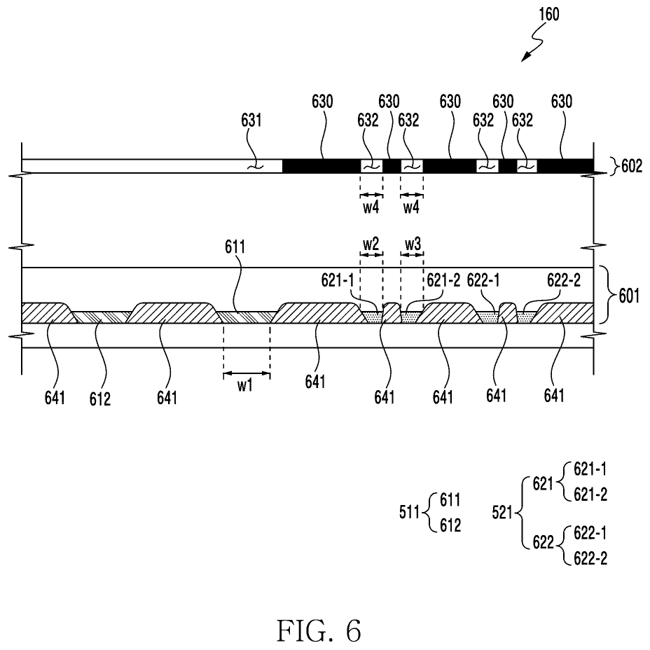

For example, an FOI of light emitted from the second pixels 520 may be narrower than an FOI of light emitted from the first pixels 510. For example, in order to narrow (or reduce) the FOI of light emitted from the second pixels 520 compared to the FOI of light emitted from the first pixels 510, a layer of the display panel 160 including the pixels may include a PDL further defining the micro-pixels of the first sub-pixel 560-1, the micro-pixels of the second sub-pixel 560-2, and the micro-pixels of the third sub-pixel 560-3. For example, in order to narrow (or reduce) the FOI of light emitted from the second pixels 520 compared to the FOI of light emitted from the first pixels 510, another layer (e.g., another layer 602 of FIG. 6) of the display panel 160 disposed on the layer (e.g., the layer 601 of FIG. 6) of the display panel 160 including the pixels may include an opaque member. The opaque member in the other layer of the display panel 160 may be partially overlying the one or more of the plurality of pixels and may not be overlying the other one or more of the plurality of pixels. The PDL in the layer of the display panel 160 and the opaque member in the other layer of the display panel 160 may be a structure for narrowing a viewing angle of at least a portion of a screen (e.g., the screen 110) displayed on the display panel 160. The opaque member disposed in the other layer of the display panel 160 according to the example configuration of FIG. 5 is described in more detail with reference to FIG. 6.

FIG. 6 is a cross-sectional view of a display panel according to the example configuration of FIG. 5.

Referring to FIG. 6, the display panel 160 may include a layer 601 and another layer 602 disposed (or positioned) on the layer 601. The layer 601 of the display panel 160 may be described as a light emission layer 601. The other layer 602 of the display panel 160 may be described as a masking layer 602 (or a mask layer 602) (or a black matrix layer 602).

The layer 601 of the display panel 160 may include first pixels 510 and second pixels 520. The first pixels 510 may include a pixel 511. The pixel 511 may include a sub-pixel 611 and a sub-pixel 612. The second pixels 520 may include a pixel 521. The pixel 521 may include a sub-pixel 621 and a sub-pixel 622. The sub-pixel 621 may include a first portion 621-1 of the sub-pixel 621 and a second portion 621-2 of the sub-pixel 621. The sub-pixel 622 may include a first portion 622-1 of the sub-pixel 622 and a second portion 622-2 of the sub-pixel 622.

The layer 601 of the display panel 160 may include a pixel definition layer (PDL) 641. The PDL 641 may define a periphery of the pixel 511 and a periphery of the pixel 521. The PDL 641 may define a periphery of the sub-pixel 611 in the pixel 511 and a periphery of the sub-pixel 612 in the pixel 511. The PDL 641 may define a periphery of the sub-pixel 621 in the pixel 521 and a periphery of the sub-pixel 622 in the pixel 521. The PDL 641 may further define a periphery of the first portion 621-1 of the sub-pixel 621 and a periphery of the second portion 621-2 of the sub-pixel 621, relative to the PDL 441 (e.g., the PDL 441 of FIG. 4). The PDL 641 may further define a periphery of the first portion 622-1 of the sub-pixel 622 and a periphery of the second portion 622-2 of the sub-pixel 622, relative to the PDL 441 (e.g., the PDL 441 of FIG. 4). For example, the PDL 641 may be disposed between the pixel 511 and the pixel 521, may be disposed between the sub-pixel 611 and the sub-pixel 612, may be disposed between the sub-pixel 621 and the sub-pixel 622, may be disposed between the first portion 621-1 of the sub-pixel 621 and the second portion 621-2 of the sub-pixel 621, and may be disposed between the first portion 622-1 of the sub-pixel 622 and the second portion 622-2 of the sub-pixel 622.

As a non-limiting example, a width w1 of the sub-pixel 611, for example defined by the PDL 641 may be wider than a width w2 of the first portion 621-1 of the sub-pixel 621, for example defined by the PDL 641 and a width w3 of the second portion 621-2 of the sub-pixel 621, for example defined by the PDL 641.

The other layer 602 of the display panel 160 may include an opaque member 630 (or a black matrix 630). The opaque member 630 may be included in the other layer 602 of the display panel 160 for the first privacy display mode and the second privacy display mode. For example, the opaque member 630 may be partially overlying the pixel 521 and may not be overlying the pixel 511, in order to narrow an FOI of light emitted from the pixel 521 compared to an FOI of light emitted from the pixel 511. For example, the opaque member 630 may partially overlap the pixel 521 among the pixel 511 and the pixel 521. For example, the opaque member 630 may be disposed above (or over) a portion of the PDL 641 defining the pixel 521 and defining sub-pixels (e.g., the sub-pixel 621 and the sub-pixel 622) in the pixel 521, and may not be disposed above (or over) another portion of the PDL 641 defining the pixel 511 and defining sub-pixels (e.g., the sub-pixel 611 and the sub-pixel 612) in the pixel 511. For example, the opaque member 630 may be further disposed above a portion of the PDL 641 defining the first portion 621-1 of the sub-pixel 621 and the second portion 621-2 of the sub-pixel 621, and a portion of the PDL 641 defining the first portion 622-1 of the sub-pixel 622 and the second portion 622-2 of the sub-pixel 622, relative to the opaque member 430 (e.g., the opaque member 430 of FIG. 4).

For example, the opaque member 630 may include an opening 631 (or a light transmittance portion 631) disposed above the pixel 511, and openings 632 (or light transmittance portions 632) disposed above the pixel 521. For example, a size of the opening 631 may be larger than a size of each of the openings 632. The sub-pixels within the pixel 511 may be described as first sub-pixels disposed below a light transmittance portion (e.g., the first light transmittance portion 631) in the other layer 602, and the sub-pixels within the pixel 521 may be described as second sub-pixels respectively disposed below other light transmittance portions (e.g., the second light transmittance portions 632) in the other layer 602, which are smaller than the light transmittance portion (e.g., the first light transmittance portion 631) in the other layer 602.

As a non-limiting example, a width w4 of an opening of the openings 632 may be equal to a width w2 of the first portion 621-1 of the sub-pixel 621 (or a width w3 of the second portion 621-2 of the sub-pixel 621). As a non-limiting example, a width w4 of an opening of the openings 632 may be wider than a width w2 of the first portion 621-1 of the sub-pixel 621 (or a width w3 of the second portion 621-2 of the sub-pixel 621). As a non-limiting example, a width w4 of an opening of the openings 632 may be narrower than a width w2 of the first portion 621-1 of the sub-pixel 621 (or a width w3 of the second portion 621-2 of the sub-pixel 621).

Referring again to FIG. 2, the electronic device 100 may provide the first privacy display mode and the second privacy display mode to protect privacy (or user privacy) with respect to displaying a screen (e.g., the screen 110) on the display panel 160. For example, the first privacy display mode and the second privacy display mode may be described as display modes for reducing a probability that information within a screen displayed on the display panel 160 is viewable by another user distinguished from a user of the electronic device 100. For example, the first privacy display mode and the second privacy display mode may be described as display modes for reducing a probability that information within a screen displayed on the display panel 160 is viewable from a second space around a first space in front of the display panel 160. For example, the first privacy display mode and the second privacy display mode may be described as display modes for reducing visibility from the second space.

For example, controlling at least a portion of the first sub-pixels and at least a portion of the second sub-pixels to provide the first privacy display mode and the second privacy display mode may have a complexity greater than that of controlling at least a portion of the first sub-pixels to provide the first privacy display mode and the second privacy display mode. For example, the electronic device 100 may control at least a portion of the first sub-pixels to provide the first privacy display mode and the second privacy display mode according to a simplified (or reduced) operation. For example, the electronic device 100 may adjust a brightness range of light emitted from the first sub-pixels based on changing the normal display mode to the first privacy display mode. For example, the electronic device 100 may maintain a brightness range of light emitted from the second sub-pixels, independently of changing the normal display mode to the first privacy display mode. For example, maintaining the brightness range of light emitted from the second sub-pixels may be performed under a condition in which a brightness setting of the display panel 160 (or the display 220) is maintained. For example, the electronic device 100 may adjust the brightness range of light emitted from the first sub-pixels, based on changing the normal display mode to the second privacy display mode. For example, the electronic device 100 may maintain the brightness range of light emitted from the second sub-pixels, independently of changing the normal display mode to the second privacy display mode. For example, maintaining the brightness range of light emitted from the second sub-pixels may be performed on a condition in which a brightness setting of the display panel 160 (or the display 220) is maintained. For example, the electronic device 100 may adjust the brightness range of light emitted from the first sub-pixels, based on changing the first privacy display mode to the second privacy display mode. For example, the electronic device 100 may adjust the brightness range of light emitted from the first sub-pixels, based on changing the first privacy display mode to the normal display mode. For example, the electronic device 100 may maintain the brightness range of light emitted from the second sub-pixels, independently of changing the first privacy display mode to the normal display mode. For example, maintaining the brightness range of light emitted from the second sub-pixels may be performed on a condition in which a brightness setting of the display panel 160 (or the display 220) is maintained. For example, the electronic device 100 may adjust the brightness range of light emitted from the first sub-pixels, based on changing the second privacy display mode to the normal display mode. For example, the electronic device 100 may maintain the brightness range of light emitted from the second sub-pixels, independently of changing the second privacy display mode to the normal display mode. For example, maintaining the brightness range of light emitted from the second sub-pixels may be performed on a condition in which a brightness setting of the display panel 160 (or the display 220) is maintained. For example, the electronic device 100 may adjust the brightness range of light emitted from the first sub-pixels, based on changing the second privacy display mode to the first privacy display mode. For example, the electronic device 100 may maintain the brightness range of light emitted from the second sub-pixels, independently of changing the second privacy display mode to the first privacy display mode. For example, maintaining the brightness range of light emitted from the second sub-pixels may be performed on a condition in which a brightness setting of the display panel 160 (or the display 220) is maintained.

For example, in order to display a screen on the display panel 160 according to the normal display mode, the display driver circuitry 221 (or the DPU 212, hereinafter referred to as the display driver circuitry 221) may control the first sub-pixels to emit light within a first brightness range and control the second sub-pixels to emit light within the first brightness range. For example, in order to display a screen on the display panel 160 according to the first privacy display mode, the display driver circuitry 221 may control the first sub-pixels to cease emitting light and control the second sub-pixels to emit light within the first brightness range. For example, in order to display a screen on the display panel 160 according to the second privacy display mode, the display driver circuitry 221 may control the first sub-pixels to emit light within a second brightness range narrower than the first brightness range and control the second sub-pixels to emit light within the first brightness range. A highest brightness level of brightness levels within the second brightness range may be lower than a highest brightness level of brightness levels within the first brightness range.

For example, the display driver circuitry 221 (or the DPU 212, hereinafter referred to as the display driver circuitry 221) may receive, from the at least one processor 210 (or the CPU 211, hereinafter referred to as the at least one processor 210), an image corresponding to a screen (e.g., the screen 110) to be displayed on the display panel 160. For example, the display driver circuitry 221 may adjust a brightness range of light emitted from the first sub-pixels, by adjusting grayscale values of a portion (e.g., corresponding to a portion of the screen displayed through the first sub-pixels) of the image associated with the first sub-pixels. For example, the display driver circuitry 221 may refrain from, bypass, skip, or omit adjusting grayscale values of the image received from the at least one processor 210 to display a screen on the display panel 160 according to the normal display mode. For example, the display driver circuitry 221 may adjust grayscale values of the portion (e.g., associated with the first sub-pixels) of the image received from the at least one processor 210 to a lowest grayscale value (e.g., ‘0’) to display a screen on the display panel 160 according to the first privacy display mode. For example, the display driver circuitry 221 may adjust a grayscale range of the grayscale values of the portion (e.g., associated with the first sub-pixels) of the image received from the at least one processor 210 from a first grayscale range to a second grayscale range narrower than the first grayscale range to display a screen on the display panel 160 according to the second privacy display mode. A highest grayscale value of the grayscale values within the second grayscale range may be lower than a highest grayscale value of the grayscale values within the first grayscale range.

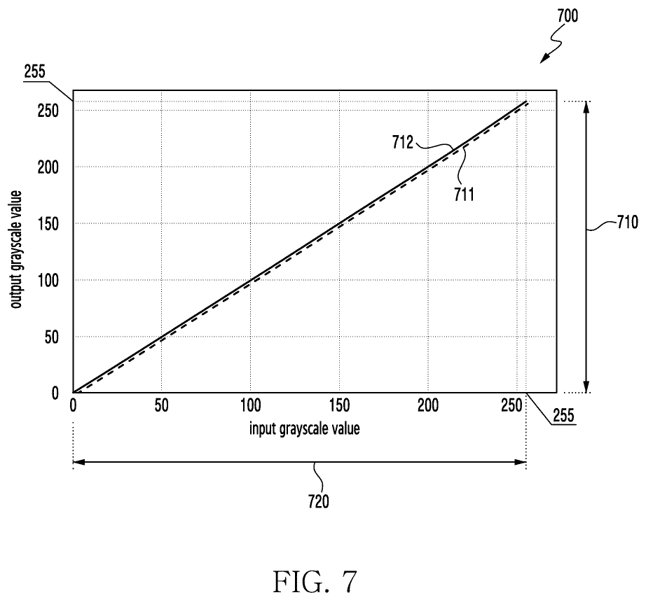

An operation of the display driver circuitry 221 performed to display a screen on the display panel 160 according to the normal display mode is described with reference to FIG. 7.

FIG. 7 is a chart illustrating a grayscale range used to control first sub-pixels and a grayscale range used to control second sub-pixels while activating a normal display mode.

Referring to FIG. 7, a horizontal axis of a chart 700 indicates an input grayscale value, and a vertical axis of the chart 700 indicates an output grayscale value. As a non-limiting example, the display driver circuitry 221 (or the DPU 212) may include processing circuitry (e.g., performed on sub-pixel basis) for narrowing a viewing angle of a screen (e.g., the screen 110) displayed on the display panel 160. For example, the processing circuitry may be included in the display driver circuitry 221 (or the DPU 212) for the first privacy display mode and the second privacy display mode. As a non-limiting example, the processing circuitry may be included in the display driver circuitry 221 (or the DPU 212) with respect to the first sub-pixels. For example, the input grayscale value may be described as a grayscale value inputted to the processing circuitry. For example, the input grayscale value may be described as a grayscale value of an image (e.g., corresponding to the screen) before (or immediately before) being provided to the processing circuitry. For example, the output grayscale value may be described as a grayscale value outputted from the processing circuitry. For example, the output grayscale value may be described as a grayscale value obtained from the processing circuitry. As a non-limiting example, the output grayscale value may correspond to a data voltage to be provided to a sub-pixel of the display panel 160.

For example, a line 711 in the chart 700 indicates a relationship between an input grayscale value associated with the first sub-pixels and an output grayscale value associated with the first sub-pixels. For example, since the normal display mode is provided while the processing circuitry is deactivated or by bypassing the processing circuitry, the output grayscale value may be equal to the input grayscale value. For example, the display driver circuitry 221 may control, by using output grayscale values each equal to input grayscale values within a grayscale range 720, the first sub-pixels, for the normal display mode. For example, the output grayscale value may be within a first grayscale range 710 equal to the grayscale range 720. For example, the display driver circuitry 221 may control the first sub-pixels to emit light within a first brightness range corresponding to the first grayscale range 710 for the normal display mode.

For example, a line 712 in the chart 700 indicates a relationship between an input grayscale value associated with the second sub-pixels and an output grayscale value associated with the second sub-pixels. For example, the display driver circuitry 221 may control, by using output grayscale values each equal to input grayscale values within a grayscale range 720, the second sub-pixels, for the normal display mode. For example, the output grayscale values may be within a first grayscale range 710 equal to the grayscale range 720. For example, the display driver circuitry 221 may control the second sub-pixels to emit light within the first brightness range for the normal display mode.

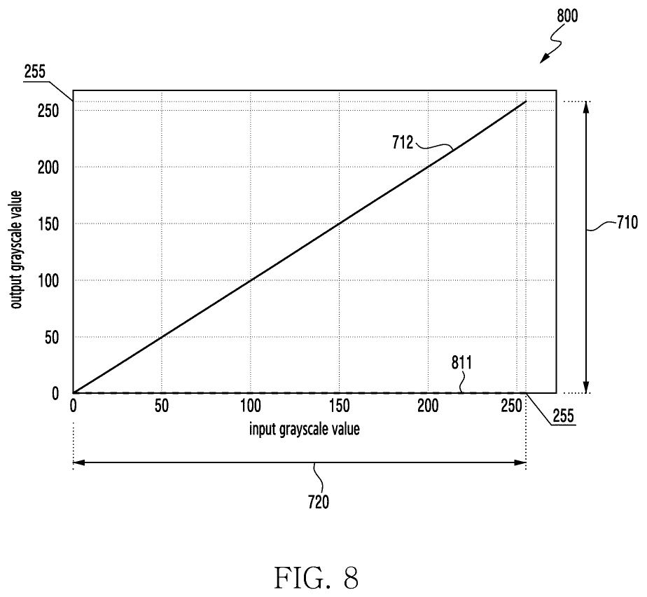

An operation of the display driver circuitry 221 performed to display a screen on the display panel 160 according to the first privacy display mode is described with reference to FIG. 8.

FIG. 8 is a chart illustrating a grayscale range used to control first sub-pixels and a grayscale range used to control second sub-pixels while activating a first privacy display mode.

Referring to FIG. 8, a horizontal axis of a chart 800 indicates an input grayscale value, and a vertical axis of the chart 800 indicates an output grayscale value. As a non-limiting example, the display driver circuitry 221 (or the DPU 212) may include processing circuitry (e.g., performed on sub-pixel basis) (e.g., the processing circuitry described with reference to FIG. 7) for narrowing a viewing angle of a screen (e.g., the screen 110) displayed on the display panel 160. For example, the input grayscale value may be described as a grayscale value inputted to the processing circuitry. For example, the input grayscale value may be described as a grayscale value of an image (e.g., corresponding to the screen) before (or immediately before) being provided to the processing circuitry. For example, the output grayscale value may be described as a grayscale value outputted from the processing circuitry. For example, the output grayscale value may be described as a grayscale value obtained from the processing circuitry. As a non-limiting example, the output grayscale value may correspond to a data voltage to be provided to a sub-pixel of the display panel 160.

For example, a line 811 in the chart 800 indicates a relationship between an input grayscale value associated with the first sub-pixels and an output grayscale value associated with the first sub-pixels. For example, since the first privacy display mode is provided in accordance with ceasing, refraining from, or deactivating emitting light through the first sub-pixels, the output grayscale value may be set to a lowest grayscale value (e.g., ‘0’), independently of the input grayscale value. For example, for the first privacy display mode, the display driver circuitry 210 may obtain output grayscale values, which are lowest grayscale values converted from input grayscale values within the grayscale range 720, by using the processing circuitry, and control the first sub-pixels by using the output grayscale values. For example, for the first privacy display mode, the display driver circuitry 210 may control the first sub-pixels to cease emitting light.

For example, a line 712 in the chart 800 indicates a relationship between an input grayscale value associated with the second sub-pixels and an output grayscale value associated with the second sub-pixels. For example, for the first privacy display mode, the display driver circuitry 210 may control the second sub-pixels by using output grayscale values each equal to input grayscale values within the grayscale range 720. For example, the output grayscale values may be within a first grayscale range 710 equal to the grayscale range 720. For example, for the first privacy display mode, the display driver circuitry 221 may control the second sub-pixels to emit light within the first brightness range.

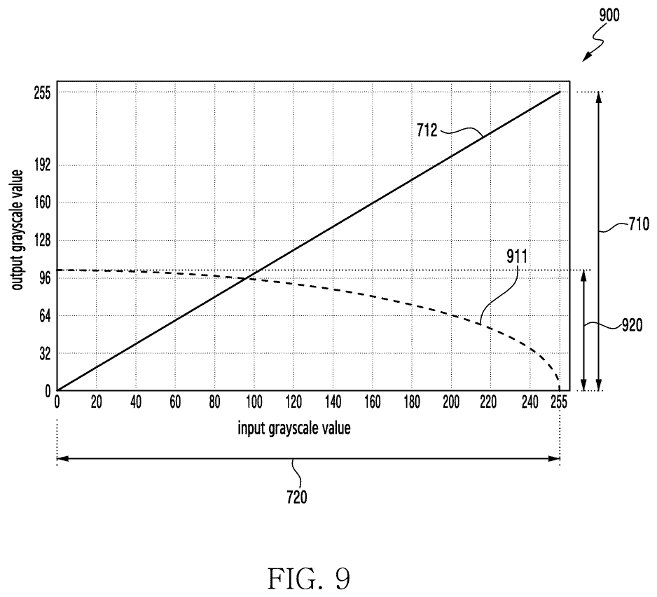

An operation of the display driver circuitry 221 performed to display a screen on the display panel 160 according to the second privacy display mode is described with reference to FIG. 9.

FIG. 9 is a chart illustrating a grayscale range used to control first sub-pixels and a grayscale range used to control second sub-pixels while activating a second privacy display mode.

Referring to FIG. 9, a horizontal axis of a chart 900 indicates an input grayscale value, and a vertical axis of the chart 900 indicates an output grayscale value. As a non-limiting example, the display driver circuitry 221 (or the DPU 212) may include processing circuitry (e.g., performed on sub-pixel basis) (e.g., the processing circuitry described with reference to FIGS. 7 and 8) for narrowing a viewing angle of a screen (e.g., the screen 110) displayed on the display panel 160. As a non-limiting example, the processing circuitry may also be used only for the second privacy display mode. For example, the input grayscale value may be described as a grayscale value inputted to the processing circuitry. For example, the input grayscale value may be described as a grayscale value of an image (e.g., corresponding to the screen) before (or immediately before) being provided to the processing circuitry. For example, the output grayscale value may be described as a grayscale value outputted from the processing circuitry. For example, the output grayscale value may be described as a grayscale value obtained from the processing circuitry. As a non-limiting example, the output grayscale value may correspond to a data voltage to be provided to a sub-pixel of the display panel 160.

For example, a line 911 in the chart 900 indicates a relationship between an input grayscale value associated with the first sub-pixels and an output grayscale value associated with the first sub-pixels. For example, since the second privacy display mode is provided in accordance with adjusting (or limiting) a brightness range of light emitted through the first sub-pixels, the output grayscale value may differ from the input grayscale value. For example, for the second privacy display mode, the display driver circuitry 210 may obtain output grayscale values respectively converted from input grayscale values within the grayscale range 720 by using the processing circuitry, and control the first sub-pixels by using the output grayscale values. For example, a viewing angle of a screen displayed on the display panel 160 according to the second privacy display mode may be adjusted by the output grayscale values. For example, the output grayscale values may be within a second grayscale range 920 narrower than the grayscale range 720. For example, the output grayscale values may be within a second grayscale range 920 narrower than the first grayscale range 710. For example, the display driver circuitry 221 may adjust a viewing angle of a screen displayed in the second privacy display mode, by controlling the first sub-pixels by using grayscale values (e.g., the output grayscale values) within the second grayscale range 920 narrower than the first grayscale range 710.

A change in an output grayscale value associated with the first sub-pixels may differ from a change in an output grayscale value associated with the second sub-pixels (or an input grayscale value associated with the first sub-pixels). A direction of a change in the output grayscale value associated with the first sub-pixels may be opposite to a direction of a change in the output grayscale value associated with the second sub-pixels (or the input grayscale value associated with the first sub-pixels). For example, the output grayscale value associated with the first sub-pixels may decrease as the output grayscale value associated with the second sub-pixels (or the input grayscale value associated with the first sub-pixels) increases.

As a non-limiting example, the output grayscale values indicated by the line 911 in the chart 900 may be determined according to a contrast ratio (CR) for the second privacy display mode. For example, the CR may be described as a ratio of a second brightness level of light emitted through a second sub-pixel (e.g., a sub-pixel among the second sub-pixels) controlled by using a highest grayscale value (e.g., ‘255’) to a first brightness level of light emitted through a first sub-pixel (e.g., a sub-pixel among the first sub-pixels) controlled by using a lowest grayscale value (e.g., ‘0’). The second brightness level may be described as a brightness level of light from a light-emitting element of the second sub-pixel measured in a second space around a first space in front of the display panel 160. For example, the second brightness level may be described as a brightness level of light from the light-emitting element of the second sub-pixel measured in a direction inclined by 45 degrees with respect to a direction of the second sub-pixel (or a direction of a display area of the display panel 160). The first brightness level may be described as a brightness level of light from a light-emitting element of the first sub-pixel measured in the second space. For example, the first brightness level may be described as a brightness level of light from the light-emitting element of the first sub-pixel measured in a direction inclined by 45 degrees with respect to a direction of the first sub-pixel (or a direction of a display area of the display panel 160).

For example, when the CR is ‘1:1’ and the second brightness level is ‘0.05, the first brightness level may be ‘0.05’. For example, when the CR is ‘2:1’ and the second brightness level is ‘0.05, the first brightness level may be ‘0.025’.

As a non-limiting example, output grayscale values indicated by the line 911 in the chart 900 may be determined by using reference data (e.g., a look-up table) set with respect to the CR. For example, the reference data may be stored in memory associated with the display driver circuitry 221 (or the DPU 212). For example, the memory associated with the display driver circuitry 221 may be included in the display driver circuitry 221. For example, the memory associated with the DPU 212 may be a portion of the memory 230. For example, the memory associated with the display driver circuitry 221 (or the DPU 212) may be described as a storage device of the electronic device 100 that stores (or records) the reference data read by the display driver circuitry 221 (or the DPU 212).

For example, the reference data when the CR is ‘1:1’ may be represented as shown in Table 1 below.

TABLE 1

| | | | First Sub-Pixel | | | | | |
|---|---|---|---|---|---|---|---|---|
| Second Sub-Pixel | | | | Target | Target | | Display Panel (160) | |
| Output | Brightness | Brightness | Input | Brightness | Brightness | Output | Brightness | Brightness |
| Grayscale | Level | Level | Grayscale | Level | Level | Grayscale | Level | Level |
| Value | (@0°) | (@45°) | Value | (@45°) | (@0°) | Value | (@45°) | (@0°) |
| 255 | 1.000 | 0.05 | 255 | 0 | 0 | 0 | 0.050 | 1.000 |
| 223 | 0.745 | 0.037 | 223 | 0.013 | 0.032 | 53 | 0.050 | 0.776 |
| 191 | 0.53 | 0.026 | 191 | 0.024 | 0.059 | 70 | 0.050 | 0.588 |
| 159 | 0.354 | 0.018 | 159 | 0.032 | 0.081 | 81 | 0.050 | 0.435 |
| 127 | 0.216 | 0.011 | 127 | 0.039 | 0.098 | 89 | 0.050 | 0.314 |
| 95 | 0.114 | 0.006 | 97 | 0.044 | 0.111 | 94 | 0.050 | 0.225 |
| 63 | 0.046 | 0.002 | 63 | 0.048 | 0.119 | 97 | 0.050 | 0.165 |
| 31 | 0.010 | 0 | 31 | 0.050 | 0.124 | 99 | 0.050 | 0.133 |
| 0 | 0.000 | 0 | 0 | 0.050 | 0.125 | 99 | 0.050 | 0.125 |

In Table 1, a ‘brightness level (@0°)’ associated with the second sub-pixel indicates a brightness level (e.g., measured in a direction of the second sub-pixel (or a direction of a display area of the display panel 160)) of light from the second sub-pixel controlled by using an ‘output grayscale value’ associated with the second sub-pixel (e.g., the same as an ‘input grayscale value’ associated with the second sub-pixel). For example, when the ‘output grayscale value’ associated with the second sub-pixel is ‘223’ and a gamma value is ‘2.2’, the ‘brightness level (@0°’ associated with the second sub-pixel is ‘0.745 (=(223/255)\hat{ }(2.2))’. In Table 1, a ‘brightness level) (@45°)’ associated with the second sub-pixel indicates a brightness level (e.g., measured in a direction inclined by 45 degrees with respect to a direction of the second sub-pixel) of light from the second sub-pixel controlled by using the ‘output grayscale value’ associated with the second sub-pixel. As a non-limiting example, the ‘brightness level (@45°)’ associated with the second sub-pixel may be 1/20 times of the ‘brightness level (@0°)’ associated with the second sub-pixel. For example, when the ‘brightness level (@0°)’ associated with the second sub-pixel is ‘0.745’, the ‘brightness level (@45°)’ associated with the second sub-pixel is ‘0.037 (=(223/255)\hat{ }(2.2)*(1/20))’.

In Table 1, the ‘input grayscale value’ associated with the first sub-pixel indicates a grayscale value inputted to the processing circuitry.

In Table 1, a ‘target brightness level (@45°)’ associated with the first sub-pixel may be determined according to the CR. For example, the ‘target brightness level (@45°)’ associated with the first sub-pixel may be determined according to Equation 1 below.

$$B 1 = ( b / a ) * B 2 * ( 1 - ( GI / 255 ) \hat{} ( r ) ) \qquad [ Equation 1 ]$$

In Equation 1, ‘a’ and ‘b’ indicate the CR of ‘a: b’, B2 indicates a ‘brightness level) (@45°)’ associated with the second sub-pixel when an ‘output grayscale value’ associated with the second sub-pixel is ‘255’, GI indicates an input grayscale value associated with the first sub-pixel, r indicates a gamma value, 255 indicates a highest grayscale value, and B1 indicates a ‘target brightness level (@45°)’ associated with the first sub-pixel.

‘a’ indicates a ‘brightness level (@45°)’ associated with the second sub-pixel, and ‘b’ indicates a ‘brightness level (@45°)’ associated with the first sub-pixel, and the CR of ‘a: b’ may indicates a difference (or ratio) (or relationship) between the ‘brightness level (@45°)’ associated with the second sub-pixel and the ‘brightness level (@45°)’ associated with the first sub-pixel. For example, when the CR of ‘a: b’ is 1:1, the ‘brightness level (@45°)’ associated with the second sub-pixel and the ‘brightness level (@45°)’ associated with the first sub-pixel may be equal to each other.

For example, when the CR is 1:1, a ‘brightness level (@45°)’ associated with the second sub-pixel is ‘0.050’ (e.g., an ‘output grayscale value’ associated with the second sub-pixel is ‘255’), a gamma value is ‘2.2’, and an input grayscale value associated with the first sub-pixel is 255, a ‘B1’ which is a ‘target brightness level (@45°)’ associated with the first sub-pixel may be ‘0.000’. In another example, when the CR is 1:1, a ‘brightness level (@45°)’ associated with the second sub-pixel is ‘0.050’ (e.g., an ‘output grayscale value’ associated with the second sub-pixel is ‘255’), a gamma value is ‘2.2’, and an input grayscale value associated with the first sub-pixel is 0, ‘B1’, which is a ‘target brightness level (@45°)’ associated with the first sub-pixel may be ‘0.050’.

In Table 1, a ‘target brightness level (@0°)’ associated with the first sub-pixel may be determined according to a ‘target brightness level (@45°)’ associated with the first sub-pixel. As a non-limiting example, the ‘target brightness level (@0°)’ associated with the first sub-pixel may be 5/2 times of the ‘target brightness level (@45°)’ associated with the first sub-pixel. For example, when the ‘target brightness level (@45°)’ associated with the first sub-pixel is determined as ‘0.050’ according to the CR as shown in Table 1, the ‘target brightness level (@0°)’ associated with the first sub-pixel is ‘0.125 (=(0.05)*2.5)’.

In Table 1, an ‘output grayscale value’ associated with the first sub-pixel may be a value corresponding to a ‘target brightness level (@0°)’ and may be indicated by the line 911 in the chart 900. For example, when a gamma value is ‘2.2’ and an ‘input grayscale value’ associated with the first sub-pixel is ‘0’, an ‘output grayscale value’ associated with the first sub-pixel is ‘99’. In another example, when a gamma value is ‘2.2’ and an ‘input grayscale value’ associated with the first sub-pixel is ‘63’, an ‘output grayscale value’ associated with the first sub-pixel is ‘97’.

In Table 1, a ‘brightness level (@45°)’ associated with the display panel 160 indicates a brightness level measured in a direction inclined by 45 degrees with respect to a direction of the display panel 160 when controlling the first sub-pixel and the second sub-pixel according to Table 1 for the second privacy display mode. The ‘brightness level (@45°)’ associated with the display panel 160 may correspond to a brightness level determined by adding a ‘brightness level (@45°’ associated with the second sub-pixel to the ‘target brightness level (@45°)’ associated with the first sub-pixel.

In Table 1, a ‘brightness level (@0°)’ associated with the display panel 160 indicates a brightness level measured in a direction of the display panel 160 when controlling the first sub-pixel and the second sub-pixel according to Table 1 for the second privacy display mode. The ‘brightness level (@0°)’ associated with the display panel 160 may correspond to a brightness level determined by adding the ‘brightness level (@0°)’ associated with the second sub-pixel to the ‘target brightness level (@0°)’ associated with the first sub-pixel.

For example, the display driver circuitry 221 may control the first sub-pixels by using grayscale values (e.g., the output grayscale values associated with the first sub-pixels) within the second grayscale range 920 for the second privacy display mode. For example, the display driver circuitry 221 may control the first sub-pixels to emit light within a second brightness range (e.g., narrower than the first brightness range described with reference to FIGS. 7 and 8) corresponding to the second grayscale range 920 for the second privacy display mode.

For example, a line 712 in the chart 900 indicates a relationship between an input grayscale value associated with the second sub-pixels and an output grayscale value associated with the second sub-pixels. For example, the display driver circuitry 210 may control the second sub-pixels by using output grayscale values each equal to input grayscale values within the grayscale range 720 for the second privacy display mode.

For example, the output grayscale values may be within a first grayscale range 710 equal to the grayscale range 720. For example, the display driver circuitry 221 may control the second sub-pixels to emit light within the first brightness range (e.g., the first brightness range described with reference to FIGS. 7 and 8) for the second privacy display mode. For example, the display driver circuitry 221 may maintain controlling the second sub-pixels by using grayscale values within the first grayscale range 710, independently of changing the first privacy display mode to the second privacy display mode or changing the normal display mode to the second privacy display mode. For example, a brightness range of light emitted by using the second sub-pixels may be maintained independently of changing the first privacy display mode to the second privacy display mode or changing the normal display mode to the second privacy display mode, as long as a brightness setting of the display panel 160 is maintained.

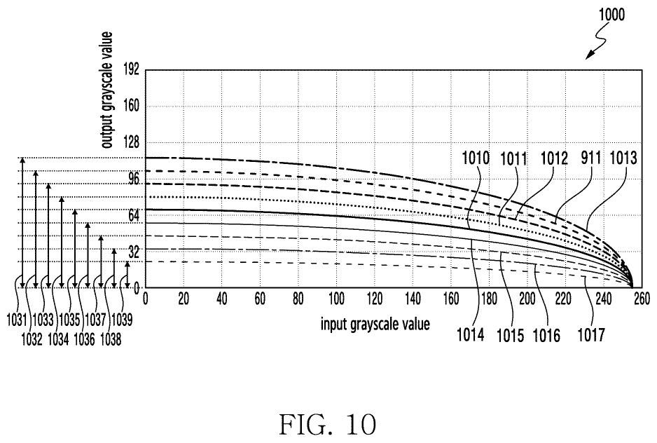

For example, in the second privacy display mode, a brightness range of light emitted through the first sub-pixels may be adjusted according to the CR. For example, in the second privacy display mode, the display driver circuitry 221 may control emitting of the second sub-pixels by using grayscale values (e.g., the output grayscale values) within the second grayscale range 920 determined according to the CR. For example, the second grayscale range 920 when the CR is ‘1:1’ may be wider than the second grayscale range 920 when the CR is ‘4:1’. For example, the display driver circuitry 221 may adjust a viewing angle of a screen displayed on the display panel 160 within the second privacy display mode by using the second grayscale range 920 changed according to a change in the CR. The second grayscale range 920 changed according to the change in the CR will be described with reference to FIG. 10.

FIG. 10 is a chart illustrating a change of a grayscale range used to control first sub-pixels while activating a second privacy display mode.

Referring to FIG. 10, the display driver circuitry 221 may adjust a viewing angle of a screen displayed on the display panel 160 within the second privacy display mode, by converting values within reference data (e.g., represented as shown in Table 1) set with respect to a reference CR (e.g., 1:1), by using the reference data. The display driver circuitry 221 may adjust side visibility (e.g., visibility from the second space) of a screen displayed on the display panel 160 within the second privacy display mode, by converting values within reference data (e.g., represented as shown in Table 1) set with respect to a reference CR (e.g., 1:1), by using the reference data.

A horizontal axis of a chart 1000 indicates an input grayscale value associated with the first sub-pixels, and a vertical axis of the chart 1000 indicates an output grayscale value associated with the first sub-pixels.

For example, the display driver circuitry 221 may control the first sub-pixels by using grayscale values (e.g., the output grayscale values) within a second grayscale range 1032 (e.g., the second grayscale range 920 of FIG. 9) indicated by a line 911 in the chart 1000 to display the screen with the viewing angle corresponding to the reference CR.

For example, the display driver circuitry 221 may control the first sub-pixels by using grayscale values (e.g., the output grayscale values) within a second grayscale range 1031 indicated by a line 1013 in the chart 1000 to display a screen with a viewing angle corresponding to a first CR higher than the reference CR. The second grayscale range 1031 may be wider than the second grayscale range 1032.

For example, the display driver circuitry 221 may control the first sub-pixels by using grayscale values (e.g., the output grayscale values) within a second grayscale range 1033 indicated by a line 1012 in the chart 1000 to display a screen with a viewing angle corresponding to a second CR higher than the first CR. The second grayscale range 1033 may be narrower than the second grayscale range 1032.

For example, the display driver circuitry 221 may control the first sub-pixels by using grayscale values (e.g., the output grayscale values) within a second grayscale range 1034 indicated by a line 1011 in the chart 1000 to display a screen with a viewing angle corresponding to a third CR higher than the second CR. The second grayscale range 1034 may be narrower than the second grayscale range 1033.

For example, the display driver circuitry 221 may control the first sub-pixels by using grayscale values (e.g., the output grayscale values) within a second grayscale range 1035 indicated by a line 1010 in the chart 1000 to display a screen with a viewing angle corresponding to a fourth CR higher than the third CR. The second grayscale range 1035 may be narrower than the second grayscale range 1034.

For example, the display driver circuitry 221 may control the first sub-pixels by using grayscale values (e.g., the output grayscale values) within a second grayscale range 1036 indicated by a line 1014 in the chart 1000 to display a screen with a viewing angle corresponding to a fifth CR higher than the fourth CR. The second grayscale range 1036 may be narrower than the second grayscale range 1035.

For example, the display driver circuitry 221 may control the first sub-pixels by using grayscale values (e.g., the output grayscale values) within a second grayscale range 1037 indicated by a line 1015 in the chart 1000 to display a screen with a viewing angle corresponding to a sixth CR higher than the fifth CR. The second grayscale range 1037 may be narrower than the second grayscale range 1036.

For example, the display driver circuitry 221 may control the first sub-pixels by using grayscale values (e.g., the output grayscale values) within a second grayscale range 1038 indicated by a line 1016 in the chart 1000 to display a screen with a viewing angle corresponding to a seventh CR higher than the sixth CR. The second grayscale range 1038 may be narrower than the second grayscale range 1037.

For example, the display driver circuitry 221 may control the first sub-pixels by using grayscale values (e.g., the output grayscale values) within a second grayscale range 1039 indicated by a line 1017 in the chart 1000 to display a screen with a viewing angle corresponding to an eighth CR higher than the seventh CR. The second grayscale range 1039 may be narrower than the second grayscale range 1038.

As a non-limiting example, the display driver circuitry 221 may perform the adjustment of the second grayscale range described above, by using Equation 2 below.

$$Gain = 1 / D \hat{} ( 1 / r ) \qquad [ Equation 2 ]$$

In Equation 2, ‘D’ indicates a difference from the reference CR, ‘r’ indicates a gamma value, and ‘Gain’ indicates a gain value applied to output grayscale values associated with the first sub-pixels in the reference data associated with the reference CR.

For example, the display driver circuitry 221 may identify (or determine) (or obtain) a second grayscale range associated with a CR changed from the reference CR by dividing each of the output grayscale values associated with the first sub-pixels in the reference data by the gain value (e.g., Gain) in Equation 2.

The above-described operations may be performed by the electronic device 1101 of FIG. 11.

FIG. 11 is a block diagram illustrating an electronic device 1101 in a network environment 1100 according to various embodiments. Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled, directly or indirectly, with the processor 1120 comprising processing circuitry, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) and/or an application processor (AP), each of course comprising processing circuitry), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or U-plane latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element comprising or of a conductive material and/or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted and/or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted and/or received between the electronic device 1101 and the external electronic device 1104 via the server 1108 coupled, directly or indirectly, with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

FIG. 12 is a block diagram 1200 illustrating the display module 1160 according to various embodiments. Referring to FIG. 12, the display module 1160 may include a display 1210 and a display driver integrated circuit (DDI) 1230 to control the display 1210. The DDI 1230 may include an interface module 1231, memory 1233 (e.g., buffer memory), an image processing module 1235, or a mapping module 1237. The DDI 1230 may receive image information that contains image data or an image control signal corresponding to a command to control the image data from another component of the electronic device 1101 via the interface module 1231. For example, according to an embodiment, the image information may be received from the processor 1120 (e.g., the main processor 1121 (e.g., an application processor)) or the auxiliary processor 1123 (e.g., a graphics processing unit) operated independently from the function of the main processor 1121. The DDI 1230 may communicate, for example, with touch circuitry 1250 or the sensor module 1176 via the interface module 1231. The DDI 1230 may also store at least part of the received image information in the memory 1233, for example, on a frame by frame basis. The image processing module 1235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1210. The mapping module 1237 may generate a voltage value or a current value corresponding to the image data pre-processed or post-processed by the image processing module 1235. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 1210 may be driven, for example, based at least in part on the voltage value or the current value such that visual information (e.g., a text, an image, or an icon) corresponding to the image data may be displayed via the display 1210.

According to an embodiment, the display module 1160 may further include the touch circuitry 1250. The touch circuitry 1250 may include a touch sensor 1251 and a touch sensor IC 1253 to control the touch sensor 1251. The touch sensor IC 1253 may control the touch sensor 1251 to sense a touch input or a hovering input with respect to a certain position on the display 1210. To achieve this, for example, the touch sensor 1251 may detect (e.g., measure) a change in a signal (e.g., a voltage, a quantity of light, a resistance, or a quantity of one or more electric charges) corresponding to the certain position on the display 1210. The touch circuitry 1250 may provide input information (e.g., a position, an area, a pressure, or a time) indicative of the touch input or the hovering input detected via the touch sensor 1251 to the processor 1120. According to an embodiment, at least part (e.g., the touch sensor IC 1253) of the touch circuitry 1250 may be formed as part of the display 1210 or the DDI 1230, or as part of another component (e.g., the auxiliary processor 1123) disposed outside the display module 1160.

According to an embodiment, the display module 1160 may further include at least one sensor (e.g., a fingerprint sensor, an iris sensor, a pressure sensor, or an illuminance sensor) of the sensor module 1176 or a control circuit for the at least one sensor. In such a case, the at least one sensor or the control circuit for the at least one sensor may be embedded in one portion of a component (e.g., the display 1210, the DDI 1230, or the touch circuitry 1250)) of the display module 1160. For example, when the sensor module 1176 embedded in the display module 1160 includes a biometric sensor (e.g., a fingerprint sensor), the biometric sensor may obtain biometric information (e.g., a fingerprint image) corresponding to a touch input received via a portion of the display 1210. As another example, when the sensor module 1176 embedded in the display module 1160 includes a pressure sensor, the pressure sensor may obtain pressure information corresponding to a touch input received via a partial or whole area of the display 1210. According to an embodiment, the touch sensor 1251 or the sensor module 1176 may be disposed between pixels in a pixel layer of the display 1210, and/or over or under the pixel layer.

Some of the operations described above may be executed (or performed) through an artificial intelligence (AI) system described with reference to FIG. 13. For example, the AI system may be used to adjust a viewing angle provided according to the second privacy display mode based on one or more contents provided by a screen displayed on the display panel 160, illuminance around the electronic device 100 (e.g., identified through an illuminance sensor (not illustrated) of the electronic device 100), luminance of a screen displayed on the display panel 160, and/or posture of the electronic device 100 (e.g., identified through an inertial sensor of the electronic device 100). For example, the AI system may be available for adjusting the second grayscale range.

FIG. 13 is a schematic diagram of an exemplary AI system.

Referring to FIG. 13, an AI system 1300 may include an input/output interface 1310, an artificial intelligence (AI) framework 1320, a generative AI model 1330, an application/service component 1380, and/or a knowledge storage 1390.

The input/output interface 1310 may receive an input. The input may include a user input and/or data obtained or generated by an electronic device (e.g., the above-described electronic device 100 or the electronic device 1101). The data may include an image, a video, and/or sensor data (e.g., illuminance data of surroundings of the electronic device obtained from a sensor or a sensor hub (e.g., the auxiliary processor 1123), posture data (or orientation data) of the electronic device, an internal temperature of the electronic device (e.g., a temperature of the display 220 or of the at least one processor 210), size information of a display area of the display 220, and/or an image obtained through an image sensor (e.g., included in the camera module 1180) of the electronic device) generated by at least one processor (e.g., the at least one processor 210 or the processor 1120) of the electronic device. The user input may include a natural language, touch data obtained through touch circuitry included in the display panel 160 (e.g., used to identify an input from a finger and/or a stylus), an image displayed (and/or to be displayed) on the display panel 160, and/or a video. As a non-limiting example, the user input may be received by the input/output interface 1310 together with context information. The context information may be described as additional information obtained in relation to the user input. The context information may be related to a state when the user input is received (e.g., including a state of the electronic device and/or a state around the electronic device (e.g., a user state)). For example, the context information may include information about one or more software applications executed in the electronic device when the user input is received. For example, the context information may include information about a position of the electronic device (or a position of a user of the electronic device) when the user input is received. For example, the user input may be integrated with the context information. For example, as the user input, the user input integrated with the context information may be received by the input/output interface 1310.

The input/output interface 1310 may transmit (or provide) an output. The output may include a result (or result information) generated or obtained by the AI system 1300 based at least in part on the input. A format of the output may vary. For example, the output may include a natural language. For example, the output may include a content (e.g., including media content and/or multimedia content). For example, the output may include an action related to a user of the electronic device. For example, the output may have a format according to user settings of the electronic device.

The input/output interface 1310 may be described as a user query/response interface 1310.

The AI framework 1320 may obtain information (or data) about the input from the input/output interface 1310 and may be used to control one or more components related to the AI system 1300 by using the obtained information.

For example, a prompt design component 1321 in the AI framework 1320 may generate or obtain a prompt for the generative AI model 1330 (e.g., including a large language model (LLM) or a large multimodal model (LMM)) by using the obtained information. For example, the prompt design component 1321 may be described as an AI component that uses a learning algorithm and/or a neural network to provide an enhanced prompt over time. For example, the prompt design component 1321 may generate or obtain a prompt by accessing a knowledge component (e.g., the knowledge storage 1390) including user preference data, a prompt library, and/or a prompt example by using the obtained information. The generated prompt may be provided to the generative AI model 1330 (e.g., including the LLM or the LMM).

For example, an API/plugin management component 1322 in the AI framework 1320 may be used to support communication for additional information requested (or caused) in relation to the prompt provided (or to be provided) to the generative AI model 1330. For example, the API/plugin management component 1322 may be used to generate or establish a channel for communication with various data sources (e.g., the knowledge storage 1390). For example, the API/plugin management component 1322 may support access to at least a portion of the data sources. For example, the API/plugin management component 1322 may be used to request another component (e.g., an application/service component 1380) that performs feedback (or response) according to the prompt. As a non-limiting example, information obtained (or generated) through the API/plugin management component 1322 may be provided to the prompt design component 1321 for generating a prompt. As a non-limiting example, information obtained (or generated) through the API/plugin management component 1322 may be provided to the generative AI model 1330.

For example, an improvement component 1323 in the AI framework 1320 may at least partially tune (or adjust) (or modify) a result (e.g., content) obtained (or outputted) from the generative AI model 1330. For example, the improvement component 1323 may determine or verify whether a content obtained from the generative AI model 1330 is related to the input. For example, the improvement component 1323 may determine or verify whether a content obtained from the generative AI model 1330 includes biased information. For example, the improvement component 1323 may determine or verify whether a content obtained from the generative AI model 1330 includes harmful content. For example, the improvement component 1323 may support or assist in performing an additional processing to improve a content obtained from the generative AI model 1330. For example, the improvement component 1323 may support providing a hint to a user to improve the content.

The generative AI model 1330 may be described as an artificial intelligence neural network that generates feedback, in response to a prompt. For example, the feedback may be related to the prompt, but may further include additional data and/or information relative to the prompt. For example, the feedback may include a new content relative to the prompt. For example, the generative AI model 1330 may include a model generating an image and/or a model generating a language. For example, the model generating an image may include a generative adversarial network (GAN) and/or a variational auto encoder (VAE). For example, the model generating an image may include a diffusion-based generative model (e.g., a transformer VAE). For example, the model generating a language may include CHAT-GPT 3 and/or CHAT-GPT 4. For example, the generative AI model 1330 may include an LMM generating the feedback by recognizing text, an image, and/or a voice.

As a non-limiting example, the AI framework 1320 and/or the generative AI model 1330 may be included in an AI module (e.g., including processing circuitry) in the electronic device. For example, the AI module may be operably coupled, directly or indirectly, with at least one processor (e.g., the at least one processor 210 or the processor 1120) of the electronic device. For example, the AI module may be operably coupled, directly or indirectly, with display driver circuitry (e.g., the display driver circuitry 221 or the DDI 1230) of the electronic device. For example, the AI module may be operably coupled, directly or indirectly, with a sensor hub of the electronic device for one or more sensors in the electronic device.

The technical problems to be achieved in this document are not limited to those described above, and other technical problems not mentioned herein will be clearly understood by those having ordinary knowledge in the art to which the present disclosure belongs, from the following description.

As described above, an electronic device (e.g., the electronic device 100) may comprise a display panel (e.g., the display panel 160) and display driver circuitry (e.g., the display driver circuitry 221). The display panel may comprise a first layer including first light transmittance portions (e.g., the light transmittance portion 461) and second light transmittance portions (e.g., the light transmittance portions 462) smaller than the first light transmittance portions, and a second layer, disposed below the first layer, including first sub-pixels respectively disposed below the first light transmittance portions and second sub-pixels respectively disposed below the second light transmittance portions. The display driver circuitry may be configured to display, via the display panel, a screen with a first viewing angle by controlling emitting of the first sub-pixels using grayscale values in a first grayscale range and controlling emitting of the second sub-pixels using grayscale values in the first grayscale range, and display, via the display panel, a screen with a second viewing angle narrower than the first viewing angle by controlling emitting of the first sub-pixels using grayscale values in a second grayscale range narrower than the first grayscale range and controlling emitting of the second sub-pixels using grayscale values in the first grayscale range.

For example, the first layer may include black matrix (BM) portions defining the second light transmittance portions. Light emitted from the second sub-pixels may be partially blocked by a portion of the BM portions.

For example, a highest grayscale value of the second grayscale range may be lower than a highest grayscale value of the first grayscale range.

For example, when the screen with the first viewing angle and the screen with the second viewing angle are identical to each other and a brightness setting for the screen with the first viewing angle and a brightness setting for the screen with the second viewing angle are equal to each other, a brightness level provided by the first sub-pixels for displaying the screen with the first viewing angle may be higher than a brightness level provided by the first sub-pixels for displaying the screen with the second viewing angle. For example, when the screen with the first viewing angle and the screen with the second viewing angle are identical to each other and the brightness setting for the screen with the first viewing angle and the brightness setting for the screen with the second viewing angle are equal to each other, a brightness level provided by the second sub-pixels for displaying the screen with the first viewing angle may be equal to a brightness level provided by the second sub-pixels for displaying the screen with the second viewing angle.

For example, the display driver circuitry may be configured to, based on changing displaying the screen with the second viewing angle to displaying the screen with a third viewing angle different from the second viewing angle, change controlling emitting of the first sub-pixels using grayscale values in the second grayscale range to controlling emitting of the first sub-pixels using grayscale values in a third grayscale range narrower than the second grayscale range, and maintain controlling emitting of the second sub-pixels using grayscale values in the first grayscale range.

For example, the second viewing angle may be wider than a threshold viewing angle. For example, the display driver circuitry may be configured to display, via the display panel, a screen with the threshold viewing angle by ceasing emitting of the first sub-pixels and controlling emitting of the second sub-pixels using grayscale values in the first grayscale range.

For example, the display driver circuitry may be configured to, for a first mode providing the first viewing angle wider than a first threshold viewing angle, control emitting of the first sub-pixels using grayscale values in the first grayscale range, and control emitting of the second sub-pixels using grayscale values in the first grayscale range, and for a second mode providing the second viewing angle that is narrower than the first threshold viewing angle and is wider than a second threshold viewing angle, control emitting of the first sub-pixels using grayscale values in the second grayscale range, and control emitting of the second sub-pixels using grayscale values in the first grayscale range.

For example, the display driver circuitry may be configured to, for a third mode providing the second threshold viewing angle, refrain from emitting of the first sub-pixels, and control emitting of the second sub-pixels using grayscale values in the first grayscale range.

As described above, an electronic device (e.g., the electronic device 100) may comprise a display panel (e.g., the display panel 160) and display driver circuitry (e.g., the display driver circuitry 221). The display panel may comprise a first layer including first light transmittance portions and second light transmittance portions smaller than the first light transmittance portions, and a second layer, disposed below the first layer of the display panel, including first sub-pixels respectively disposed below the first light transmittance portions and second sub-pixels respectively disposed below the second light transmittance portions. The display driver circuitry may be configured to display, via the display panel, a screen with a first viewing angle by controlling the first sub-pixels to emit light in a first brightness range and controlling the second sub-pixels to emit light in the first brightness range, and display, via the display panel, a screen with a second viewing angle narrower than the first viewing angle by controlling the first sub-pixels to emit light in a second brightness range narrower than the first brightness range and controlling the second sub-pixels to emit light in the first brightness range.

For example, the first layer may include black matrix (BM) portions defining the second light transmittance portions. Light emitted from the second sub-pixels may be partially blocked by a portion of the BM portions.

For example, a highest brightness level of the second brightness range may be lower than a highest brightness level of the first brightness range. For example, when the screen with the first viewing angle and the screen with the second viewing angle are identical to each other and a brightness setting for the screen with the first viewing angle and a brightness setting for the screen with the second viewing angle are equal to each other, a brightness level provided by the first sub-pixels for displaying the screen with the first viewing angle may be higher than a brightness level provided by the first sub-pixels for displaying the screen with the second viewing angle. For example, when the screen with the first viewing angle and the screen with the second viewing angle are identical to each other and the brightness setting for the screen with the first viewing angle and the brightness setting for the screen with the second viewing angle are equal to each other, a brightness level provided by the second sub-pixels for displaying the screen with the first viewing angle may be equal to a brightness level provided by the second sub-pixels for displaying the screen with the second viewing angle.

For example, the display driver circuitry may be configured to, based on changing displaying the screen with the second viewing angle to displaying the screen with a third viewing angle different from the second viewing angle, change controlling the first sub-pixels to emit light in the second brightness range to controlling the first sub-pixels to emit light in a third brightness range narrower than the second brightness range, and maintain controlling the second sub-pixels to emit light in the first brightness range.

For example, the second viewing angle may be wider than a threshold viewing angle. For example, the display driver circuitry may be configured to display, via the display panel, a screen with the threshold viewing angle by controlling the first sub-pixels to cease emitting light and controlling the second sub-pixels to emit light in the first brightness range.

For example, the display driver circuitry may be configured to, for a first mode providing the first viewing angle wider than a first threshold viewing angle, control the first sub-pixels to emit light in the first brightness range, and control the second sub-pixels to emit light in the first brightness range, and for a second mode providing the second viewing angle that is narrower than the first threshold viewing angle and is wider than a second threshold viewing angle, control the first sub-pixels to emit light in the second brightness range, and control the second sub-pixels to emit light in the first brightness range.

For example, the display driver circuitry may be configured to, for a third mode providing the second threshold viewing angle, control the first sub-pixels to refrain from emitting light, and control the second sub-pixels to emit light in the first brightness range.

As described above, the electronic device (e.g., the electronic device 100) may comprise a display panel (e.g., the display panel 160) and display driver circuitry (e.g., the display driver circuitry 221). The display panel may comprise a first layer including first light transmittance portions and second light transmittance portions smaller than the first light transmittance portions. The display panel may comprise a second layer, disposed below the first layer of the display panel, including first sub-pixels respectively disposed below the first light transmittance portions and second sub-pixels respectively disposed below the second light transmittance portions. The display driver circuitry may be configured to, based on a normal display mode, display a screen on the display panel, by emitting light through the first sub-pixels and emitting light through the second sub-pixels, based on changing the normal display mode to a first privacy display mode while the screen is maintained on the display panel, cease emitting light through the first sub-pixels, and based on changing the normal display mode to a second privacy display mode while the screen is maintained on the display panel, narrow a brightness range of light emitted through the first sub-pixels. Each “layer” herein may comprise one or more layers.

For example, the display driver circuitry may be configured to maintain emitting light through the second sub-pixels, independently of changing the normal display mode to the first privacy display mode while the screen is maintained on the display panel.

For example, the display driver circuitry may be configured to maintain a brightness range of light emitted through the second sub-pixels, independently of changing the normal display mode to the second privacy display mode while the screen is maintained on the display panel.

For example, the electronic device may comprise at least one processor (e.g., the at least one processor 210) comprising processing circuitry, and memory (e.g., the memory 230), comprising one or more storage media, storing instructions. For example, the instructions, when executed individually or collectively by the at least one processor, may cause the electronic device to transmit at least one first command indicating the first privacy display mode to the display driver circuitry and transmit at least one second command indicating the second privacy display mode to the display driver circuitry. For example, the display driver circuitry may be configured to change the normal display mode to the first privacy display mode while the screen is maintained on the display panel, based on the at least one first command received from the at least one processor, and change the normal display mode to the second privacy display mode while the screen is maintained on the display panel based on the at least one second command received from the at least one processor. “Based on” as used herein covers based at least on.

For example, the electronic device may comprise at least one processor (e.g., the at least one processor 210) comprising processing circuitry, and memory (e.g., the memory 230), comprising one or more storage media, storing instructions. For example, the instructions, when executed individually or collectively by the at least one processor, may cause the electronic device to transmit, to the display driver circuitry, an image for displaying the screen on the display panel. For example, the display driver circuitry may receive the image from the at least one processor and may be configured to narrow a brightness range of light emitted through the first sub-pixels by changing grayscale values within a first grayscale range of a portion of the image corresponding to a portion of the screen displayed through the first sub-pixels to grayscale values within a second grayscale range narrower than the first grayscale range based on changing the normal display mode to the second privacy display mode while the screen is maintained on the display panel.

For example, the display driver circuitry may be configured to maintain grayscale values within the first grayscale range of another portion of the image corresponding to another portion of the screen displayed through the second sub-pixels, independently of changing the normal display mode to the second privacy display mode while the screen is maintained on the display panel.

The effects that can be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via at least a third element(s).

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device comprising:
a display panel comprising:
a first layer including first light transmittance portions and second light transmittance portions smaller than the first light transmittance portions, and
a second layer, disposed below at least the first layer of the display panel, including first sub-pixels disposed below each of the first light transmittance portions and second sub-pixels respectively disposed below the second light transmittance portions; and
display driver circuitry configured to:
display, via the display panel, a screen with a first viewing angle at least by controlling emitting of the first sub-pixels using grayscale values in a first grayscale range and controlling emitting of the second sub-pixels using grayscale values in the first grayscale range, and
display, via the display panel, a screen with a second viewing angle narrower than the first viewing angle at least by controlling emitting of the first sub-pixels using grayscale values in a second grayscale range narrower than the first grayscale range and controlling emitting of the second sub-pixels using grayscale values in the first grayscale range.

2. The electronic device of claim 1, wherein a highest grayscale value of the second grayscale range is lower than a highest grayscale value of the first grayscale range,
wherein the first layer includes black matrix (BM) portions at least partially defining the second light transmittance portions, and
wherein the BM portions are configured so that light emitted from the second sub-pixels is at least partially blocked by a portion of the BM portions.

3. The electronic device of claim 1, wherein the electronic device is configured so that when the screen with the first viewing angle and the screen with the second viewing angle are identical to each other and a brightness setting for the screen with the first viewing angle and a brightness setting for the screen with the second viewing angle are equal to each other, a brightness level provided by the first sub-pixels for displaying the screen with the first viewing angle is higher than a brightness level provided by the first sub-pixels for displaying the screen with the second viewing angle, and
when the screen with the first viewing angle and the screen with the second viewing angle are identical to each other and the brightness setting for the screen with the first viewing angle and the brightness setting for the screen with the second viewing angle are equal to each other, a brightness level provided by the second sub-pixels for displaying the screen with the first viewing angle is equal to a brightness level provided by the second sub-pixels for displaying the screen with the second viewing angle.

4. The electronic device of claim 1, wherein the display driver circuitry is configured to:
based on changing displaying the screen with the second viewing angle to displaying a screen with a third viewing angle different from the second viewing angle:
change controlling emitting of the first sub-pixels using grayscale values in the second grayscale range to controlling emitting of the first sub-pixels using grayscale values in a third grayscale range narrower than the second grayscale range, and
maintain controlling emitting of the second sub-pixels using grayscale values in the first grayscale range.

5. The electronic device of claim 1, wherein the second viewing angle is wider than a threshold viewing angle, and
wherein the display driver circuitry is configured to:
display, via the display panel, a screen with the threshold viewing angle at least by ceasing emitting of the first sub-pixels and controlling emitting of the second sub-pixels using grayscale values in the first grayscale range.

6. The electronic device of claim 1, wherein the display driver circuitry is configured to:
for a first mode providing the first viewing angle wider than a first threshold viewing angle:
control emitting of the first sub-pixels using grayscale values in the first grayscale range, and
control emitting of the second sub-pixels using grayscale values in the first grayscale range; and
for a second mode providing the second viewing angle that is narrower than the first threshold viewing angle and is wider than a second threshold viewing angle:
control emitting of the first sub-pixels using grayscale values in the second grayscale range, and
control emitting of the second sub-pixels using grayscale values in the first grayscale range.

7. The electronic device of claim 6, wherein the display driver circuitry is configured to:
for a third mode providing the second threshold viewing angle:
refrain from emitting of the first sub-pixels, and
control emitting of the second sub-pixels using grayscale values in the first grayscale range.

8. An electronic device comprising:
a display panel comprising:
a first layer including first light transmittance portions and second light transmittance portions smaller than the first light transmittance portions, and
a second layer, disposed below at least the first layer of the display panel, including first sub-pixels disposed below each of the first light transmittance portions and second sub-pixels respectively disposed below the second light transmittance portions; and
display driver circuitry configured to:
display, via the display panel, a screen with a first viewing angle at least by controlling the first sub-pixels to emit light in a first brightness range and controlling the second sub-pixels to emit light in the first brightness range, and
display, via the display panel, a screen with a second viewing angle narrower than the first viewing angle at least by controlling the first sub-pixels to emit light in a second brightness range narrower than the first brightness range and controlling the second sub-pixels to emit light in the first brightness range.

9. The electronic device of claim 8, wherein a highest brightness level of the second brightness range is lower than a highest brightness level of the first brightness range,
wherein the first layer includes black matrix (BM) portions at least partially defining the second light transmittance portions, and
wherein the electronic device is configured so that light emitted from the second sub-pixels is at least partially blocked by the BM portions.

10. The electronic device of claim 8, wherein the electronic device is configured so that when the screen with the first viewing angle and the screen with the second viewing angle are identical to each other and a brightness setting for the screen with the first viewing angle and a brightness setting for the screen with the second viewing angle are equal to each other, a brightness level provided by the first sub-pixels for displaying the screen with the first viewing angle is higher than a brightness level provided by the first sub-pixels for displaying the screen with the second viewing angle, and
when the screen with the first viewing angle and the screen with the second viewing angle are identical to each other and the brightness setting for the screen with the first viewing angle and the brightness setting for the screen with the second viewing angle are equal to each other, a brightness level provided by the second sub-pixels for displaying the screen with the first viewing angle is equal to a brightness level provided by the second sub-pixels for displaying the screen with the second viewing angle.

11. The electronic device of claim 8, wherein the display driver circuitry is configured to:
based on changing displaying the screen with the second viewing angle to displaying the screen with a third viewing angle different from the second viewing angle:
change controlling the first sub-pixels to emit light in the second brightness range to controlling the first sub-pixels to emit light in a third brightness range narrower than the second brightness range, and
maintain controlling the second sub-pixels to emit light in the first brightness range.

12. The electronic device of claim 8, wherein the second viewing angle is wider than a threshold viewing angle, and
wherein the display driver circuitry is configured to:
display, via the display panel, a screen with the threshold viewing angle by controlling the first sub-pixels to cease emitting light and controlling the second sub-pixels to emit light in the first brightness range.

13. The electronic device of claim 8, wherein the display driver circuitry is configured to:
for a first mode providing the first viewing angle wider than a first threshold viewing angle:
control the first sub-pixels to emit light in the first brightness range, and
control the second sub-pixels to emit light in the first brightness range; and
for a second mode providing the second viewing angle that is narrower than the first threshold viewing angle and is wider than a second threshold viewing angle:
control the first sub-pixels to emit light in the second brightness range, and
control the second sub-pixels to emit light in the first brightness range.

14. The electronic device of claim 13, wherein the display driver circuitry is configured to:
for a third mode providing the second threshold viewing angle:
control the first sub-pixels to refrain from emitting light, and
control the second sub-pixels to emit light in the first brightness range.

15. An electronic device comprising:
a display panel comprising:
a first layer including first light transmittance portions and second light transmittance portions smaller than the first light transmittance portions, and
a second layer, disposed below at least the first layer of the display panel, including first sub-pixels disposed below each of the first light transmittance portions and second sub-pixels respectively disposed below the second light transmittance portions; and
display driver circuitry configured to:
based on a normal display mode, display, on the display panel, a screen at least by emitting light through the first sub-pixels and emitting light through the second sub-pixels,
based on changing the normal display mode to a first privacy display mode while the screen is maintained on the display panel, cease emitting light through the first sub-pixels, and
based on changing the normal display mode to a second privacy display mode while the screen is maintained on the display panel, narrow a brightness range of light emitted through the first sub-pixels.

16. The electronic device of claim 15, wherein the display driver circuitry is configured to:
independent of changing the normal display mode to the first privacy display mode while the screen is maintained on the display panel, maintain emitting light through the second sub-pixels.

17. The electronic device of claim 15, wherein the display driver circuitry is configured to:
independent of changing the normal display mode to the second privacy display mode while the screen is maintained on the display panel, maintain a brightness range of light emitted through the second sub-pixels.

18. The electronic device of claim 15, further comprising:
at least one processor comprising processing circuitry; and
memory, storing instructions, comprising one or more storage media,
wherein the instructions, when executed by the at least one processor individually and/or collectively, cause the electronic device to:
transmit, to the display driver circuitry, at least one first command indicating the first privacy display mode, and
transmit, to the display driver circuitry, at least one second command indicating the second privacy display mode, and
wherein the display driver circuitry is configured to:
based on the at least one first command received from the at least one processor, change, while the screen is maintained on the display panel, the normal display mode to the first privacy display mode, and
based on the at least one second command received from the at least one processor, change, while the screen is maintained on the display panel, the normal display mode to the second privacy display mode.

19. The electronic device of claim 15, further comprising:
at least one processor comprising processing circuitry; and
memory, storing instructions, comprising one or more storage media,
wherein the instructions, when executed by the at least one processor individually and/or collectively, cause the electronic device to:
transmit, to the display driver circuitry, an image to display the screen on the display panel, and
wherein the display driver circuitry is configured to:
receive, from the at least one processor, the image, and
based on changing the normal display mode to the second privacy display mode while the screen is maintained on the display panel, narrow the brightness range of light emitted through the first sub-pixels by changing grayscale values in a first grayscale range of a portion of the image corresponding to a portion of the screen displayed through the first sub-pixels to grayscale values in a second grayscale range narrower than the first grayscale range.

20. The electronic device of claim 19, wherein the display driver circuitry is configured to:
independent of changing the normal display mode to the second privacy display mode while the screen is maintained on the display panel, maintain grayscale values in the first grayscale range of another portion of the image corresponding to another portion of the screen displayed through the second sub-pixels.
